(19) United States
(12) Patent Application Publication
(10) Pub. No.: US 2024/0400365 A1
(43) Pub. Date: Dec. 5, 2024

(54) SCALABLE SYSTEMS AND METHODS FOR SELECTIVELY DISPENSING BEVERAGES

(71) Applicant: Versabev, Inc., Wilmington, DE (US)

(72) Inventors: Sal Comunale, Harrison, NY (US); Sam Sweeney, Wilmington, DE (US); Michael Kost, Wilmington, DE (US); Jon Tze, Wilmington, DE (US); Owen McEnroe, Wilmington, DE (US)

(73) Assignee: Versabev, Inc., Wilmington, DE (US)

(21) Appl. No.: 18/734,918

(22) Filed: Jun. 5, 2024

Related U.S. Application Data
(60) Provisional application No. 63/506,359, filed on Jun. 5, 2023.

(51) Int. Cl. B67D 1/00; B67D 1/04; B67D 1/12

(52) U.S. Cl. CPC B67D 1/0043; B67D 1/0074; B67D 1/04; B67D 1/1234

(57) ABSTRACT

An example system comprises a pressurized environment within an incompressible, airtight pressurized container which includes a hollow housing portion and an outer portion. The pressurized container may be airtight and operable to maintain a pressure level in the pressurized environment in the hollow housing portion. The pressurized environment may be generated by a controllable pressure system coupled to the airtight pressurized container through a pressure delivery conduit. The system may receive a request for a serving of beer. The system may control, through a control interface, opening and closing a first and second liquid transport conduit to enable a flow of beer concentrate from a first compressible container stored within the hollow housing portion and a flow of alcohol from a second compressible container stored within the hollow housing portion, respectively. The flow of beer concentrate and the flow of alcohol may be propelled by pressure. The system may mix the flow of beer concentrate and the flow of alcohol to generate re-hydrated beer to be dispensed.

### CROSS-REFERENCE TO RELATED APPLICATIONS

This application claims priority to U.S. Provisional Patent Application No. 63/506,359, filed on Jun. 5, 2023, and entitled “Scalable Modular System and Method for Temperature Control and Selectively Dispensing Beverages,” which is incorporated in its entirety herein by reference.

### FIELD OF THE INVENTION(S)

Some embodiments described herein generally relate to systems and methods for re-alcoholizing, storing, and dispensing liquids.

### BACKGROUND

Systems and methods described herein relate to systems and methods for selectively dispensing liquids (such as beer, wine, similar beverages, foodstuffs, provisions, chemicals, and/or the like) stored in a pressurized environment by utilizing a controlled source of pressure force to apply sufficient pressure to the pressurized environment to dispense a portion of the stored material in accordance with a desired dispensing regime.

In the current beer distribution and bar industry, the method of transporting beer, wine, and other alcoholic beverages in kegs, aluminum cans, or glass bottles is both heavy and produces a large amount of waste. For example, aluminum containers have a high carbon footprint and are responsible for over 11 tonnes of carbon dioxide emissions per ton of cans. Restaurants, cafes, and bars have traditionally relied on bottles, cans, and kegs to transport alcoholic beverages such as beer and distribute them to patrons. Many patrons prefer draft beer or beer dispensed from a keg. However, transporting kegs and other bulk containers, such as bottles and cans, to restaurants, café, and bars is energy intensive.

The increasing consumption of wine and similar beverages, both in various commercial establishments (e.g., restaurants, bars, and/or lounges) and in consumer homes, has resulted not only in growing consumer demand for a wider selection of beverages made available in commercial establishments (leading to the proliferation of dedicated wine bars, microbreweries, and custom cocktail establishments) but also fueled the desire of many consumers to be able to bring the equivalent experience to their home.

To address the disadvantages of the use of bottled wine in commercial establishments, various companies proposed the utilization of larger volume/less expensive “wine bags” (often offered in a “wine-in-bag”/“bag-in-box” format) (referred to herein as “WinB products”) or alcoholic syrup stored in Bag-In-Box (“BiB”) products.

### BRIEF DESCRIPTION OF THE DRAWINGS

In the drawings, wherein like reference characters denote corresponding or similar elements throughout the various figures:

FIG. 1A is an illustrative diagram of a dispensing system capable of re-alcoholizing, storing, preserving, managing, and selectively dispensing beverages or, in some embodiments.

FIG. 1B is an illustrative diagram of another dispensing system capable of re-alcoholizing, storing, preserving, managing, and selectively dispensing beverages or in some embodiments.

FIG. 2A is an illustrative diagram of a dispensing system capable of re-alcoholizing, storing, preserving, managing, and selectively dispensing beverages or in some embodiments.

FIG. 2B is an illustrative diagram of the pressurized container of the dispensing system of FIG. 2A.

FIG. 3 is a block diagram of an example dispensing control system according to some embodiments.

FIG. 4 is an illustrative diagram of a dispensing system capable of re-alcoholizing, storing, preserving, managing, and selectively dispensing beverages or food-like substances in some embodiments.

FIG. 5A is a flow chart of a method of dispensing a beverage according to some embodiments.

FIG. 5B is a flow chart of a particular step of the method of dispensing a beverage of FIG. 5A.

FIG. 6 is a flow chart of a method of dispensing a beverage according to some embodiments.

FIG. 7A is an example user interface for a dispensing system that can customize a blending profile according to some embodiments.

FIG. 7B is an example user interface for a dispensing system to dispense beverages based on blending profiles according to some embodiments.

FIG. 8 is an illustrative diagram of an example mix propeller according to some embodiments.

FIG. 9 is an illustrative diagram of an example in-line mixing chamber according to some embodiments.

FIG. 10 is an illustrative diagram of an example vortex generator according to some embodiments.

FIG. 11 is an illustrative diagram of an ultrasonic homogenizer according to some embodiments.

FIG. 12 is an illustrative diagram of an example of post-dispense injection mixing according to some embodiments.

FIG. 13 is an illustrative diagram of an example of pre-dispense mixing according to some embodiments.

FIG. 14A is an illustrative diagram of a dispensing interface according to some embodiments.

FIG. 14B is an illustrative diagram of a dispensing interface that includes multiple dispensing pour unit components according to some embodiments.

FIG. 14C is an illustrative diagram of a dispensing interface that includes a dispensing pour unit multi-pour nozzle element according to some embodiments.

FIG. 15 is an illustrative diagram of two perspective views of a dispensing interface 1500 according to some embodiments.

FIG. 16 includes one example of measurements for some dimensions of an example dispensing interface.

FIG. 17A is an illustrative diagram of a pressurized container 1700 according to some embodiments.

FIG. 17B is an illustrative diagram of the pressurized container 1600, where the lid portion 1702 is in an open position.

FIG. 18 is an illustrative diagram of a dispensing system capable of re-alcoholizing and selectively dispensing beverages or food-like substances in some embodiments.

FIG. 19 is an illustrative diagram of an example dispensing system with a user interface and temperature control according to some embodiments.

FIG. 20 is an example of a digital device in some embodiments.

### SUMMARY

An example method includes generating a pressurized environment within an incompressible, airtight pressurized container, the incompressible, pressurized container including a hollow housing portion and an outer portion, the pressurized container being airtight and operable to maintain a pressure level in the pressurized environment in the hollow housing portion, the pressurized environment being generated by a controllable pressure system coupled to the airtight pressurized container through a pressure delivery conduit; receiving, from a user interface, a request for a serving of beer; controlling, through a control interface, opening and closing a first liquid transport conduit and a second liquid transport conduit to enable a flow of beer concentrate from a first compressible container stored within the hollow housing portion and a flow of alcohol from a second compressible container stored within the hollow housing portion, respectively, the flow of beer concentrate and the flow of alcohol being propelled by pressure of the pressurized environment from within the hollow housing portion; mixing, by a mixing apparatus, the flow of beer concentrate and the flow of alcohol to generate re-hydrated beer; and dispensing the re-hydrated beer.

In some embodiments, the method further includes retrieving a profile based on the request for a serving of beer. The profile may indicate a length of time to keep the first liquid transport conduit open and a second length of time to keep the second liquid transport conduit open. Controlling of opening and closing the first and second liquid transport conduits may include opening and keeping open the first and second liquid transport conduits for the first length of time and the second length of time from the profile, respectively, and closing the first and second liquid transport conduits. Opening and closing the first liquid transport conduit may include opening a solenoid valve that allows the beer concentrate to flow through the first liquid transport conduit.

The user interface and the control interface are part of a kiosk. The alcohol may be any alcohol, including, for example, vodka.

In some embodiments, the profile further indicates an amount of carbonation to add to the re-hydrated beer and the method further includes adding the amount of carbonation to the re-hydrated beer prior to dispensing. The method may include receiving an indication of an amount of head to have on the re-hydrated beer, the amount of carbonation being based on the indication of the amount of head. When adding the amount of carbonation to the re-hydrated beer, the method may include adding carbonation to an amount of water received from a water line that is outside the incompressible pressurized container.

In various embodiments, the method may further include authenticating, by an authentication module, a consumer ID and dispensing the re-hydrated beer only if the consumer ID is authenticated.

An example system includes an incompressible, airtight pressurized container including a hollow housing portion and an outer portion. The pressurized container may be airtight and operable to maintain a pressure level in a pressurized environment in the hollow housing portion. The pressurized environment may be generated by a controllable pressure system coupled to the airtight pressurized container through a pressure delivery conduit. A user interface may be configured to receive a request for a serving of beer. A control interface may be configured to open and close a first liquid transport conduit and a second liquid transport conduit to enable a flow of beer concentrate from a first compressible container stored within the hollow housing portion and a flow of alcohol from a second compressible container stored within the hollow housing portion, respectively. The flow of beer concentrate and the flow of alcohol may be propelled by pressure of the pressurized environment from within the hollow housing portion. A mixing apparatus may be configured to mix the flow of beer concentrate and the flow of alcohol to generate re-hydrated beer. A dispensing system may be configured to dispense the re-hydrated beer.

The system may further include data storage that includes a profile associated with the request for a serving of beer. The profile may indicate a length of time to keep the first liquid transport conduit open and a second length of time to keep the second liquid transport conduit open. The control interface may be configured to open and close the first and second liquid transport conduits. In some embodiments, the control interface is configured to open and keep open the first and second liquid transport conduits for the first length of time and the second length of time from the profile, respectively, and close the first and second liquid transport conduits.

The control interface configured to open and close the first liquid transport conduit may include the control interface configured to open a solenoid valve that allows the beer concentrate to flow through the first liquid transport conduit. The user interface and the control interface are part of a kiosk. The alcohol may be any alcohol, including, for example, vodka.

In some embodiments, the profile may further indicate an amount of carbonation to add to the re-hydrated beer. The system may include a carbonator configured to add the amount of carbonation to the re-hydrated beer prior to dispensing. The control interface may be further configured to receive an indication of an amount of head to have on the re-hydrated beer. The carbonator may be configured to provide amount of carbonation being based on the indication of the amount of head. The carbonator configured to add the amount of carbonation to the re-hydrated beer may include the carbonator configured to add carbonation to an amount of water received from a water line that is outside the incompressible pressurized container.

The system may further include an authentication module configured to authenticate a consumer ID and dispensing the re-hydrated beer only if the consumer ID is authenticated.

### DETAILED DESCRIPTION

Various embodiments discussed herein address various beverage dispensing systems that remedy the flaws and drawbacks of previously known storage and dispensing solutions (and especially larger-scale commercial solutions) by storing a plurality of liquid and semi-liquid product (e.g., various beer, wines, beverages, foods, chemicals, and the like) in a pressurized environment.

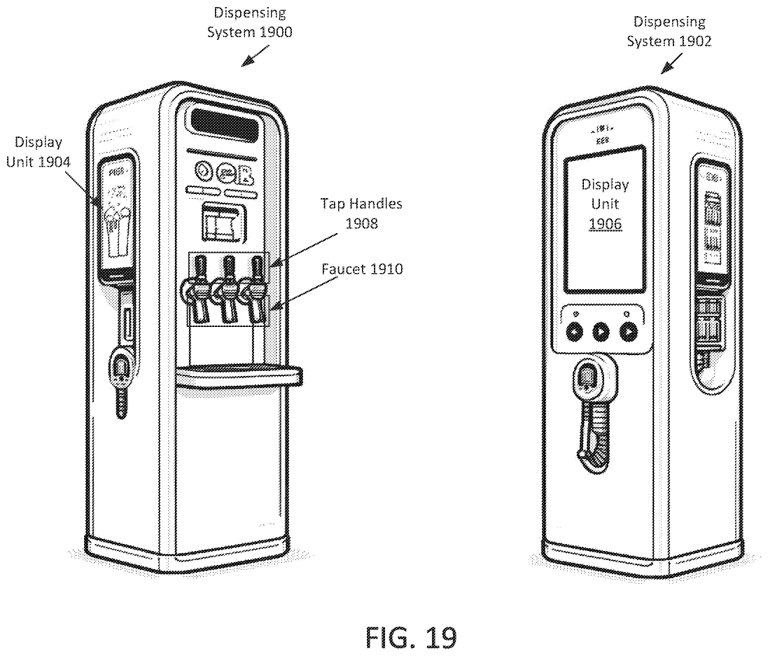

In one example, systems and methods discussed herein include systems and methods for re-alcoholizing, storing, preserving, managing, and selectively dispensing beverages. In this example, the beverage dispensing system may reconstitute beer at a location where the final product (e.g., reconstituted beer) is served. The systems and methods may also enable control of foam, carbonation, temperature, and/or ingredient ratios. The beverage dispensing system may include a temperature control system, an example of which can be seen in FIG. 19.

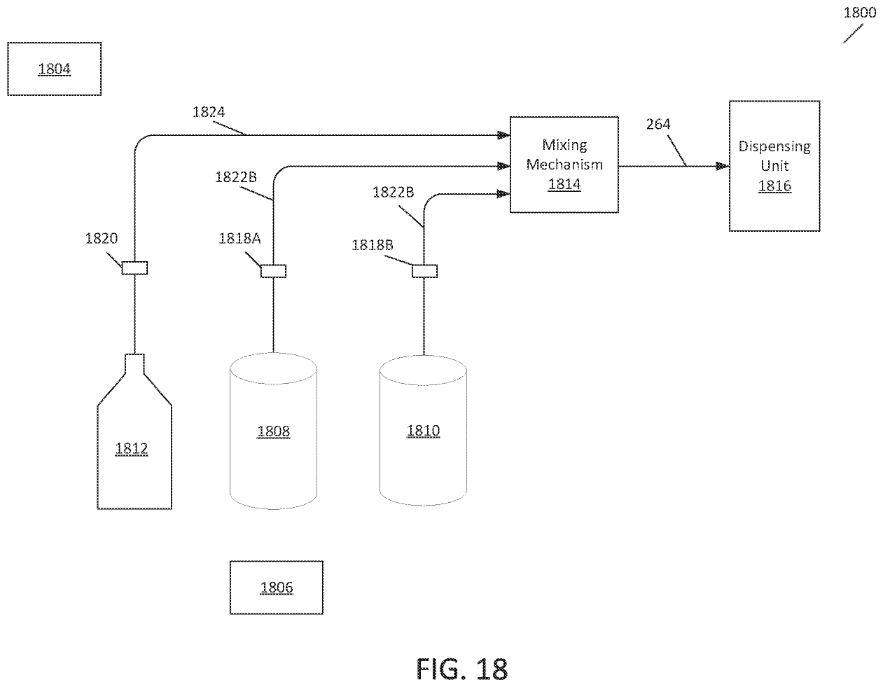

In some embodiments, one or more compressible beverage containers may include dehydrated materials (e.g., for dehydrated beer). The compressible containers may be placed into at least one pressurized chamber (serving as the pressurized environment) and interfaced with a delivery system connected to one or more dispensing components such as those shown in the pressurization-based dispensing technology disclosed in the commonly assigned issued U.S. patent Ser. No. 14/055,876, now issued as U.S. Pat. No. 9,242,845, entitled “SYSTEM AND METHOD FOR STORING AND SELECTIVELY DISPENSING LIQUIDS”, which is hereby incorporated by reference herein in its entirety, has provided various embodiments of a Pressurized Liquid Storage and Dispensing system (which is hereby referred to as the “PLSMPD system”). The system may be scalable by utilizing any number of products (for example, implemented with a simplified embodiment of the system, such as is shown in FIG. 18 and described in greater detail below in connection therewith).

The system may be deployed as a flexible multi-area electronically-controlled beverage dispensing infrastructure, operable to interface with various hospitality (e.g., restaurant) management systems. For example, the system may be implemented with one or more embodiments and optional features of a PLSMPD system.

Some embodiments described herein resolve one or more of the disadvantages of previously known beer dispensing systems and/or WinB products and their dispensing containers in commercial environments. Various embodiments include systems and methods for preserved storage and selectively controlled dispensation of beverages, such as wine, beer, vodka, smoothies, coffees, beer syrup, re-hydrated beer (e.g., re-alcoholized beer), soft serve, and/or the like, that are configurable for use with a variety of products, and their equivalents. The system may be modular and readily scalable for advantageous utilization in environments ranging from consumer homes to large commercial/hospitality establishments.

It should be noted that while various descriptions of the system and method describe the utilization of alcoholic beverages, one skilled in the art will appreciate that various embodiments of the can be readily utilized in conjunction with storage and selective dispensation of any beverage, liquid substance, food substance, chemical, or the like as a matter of design choice or necessity. Similarly, virtually any compressible container can be readily substituted or even integrated into the pressurized chamber (e.g., as a lining or the like).

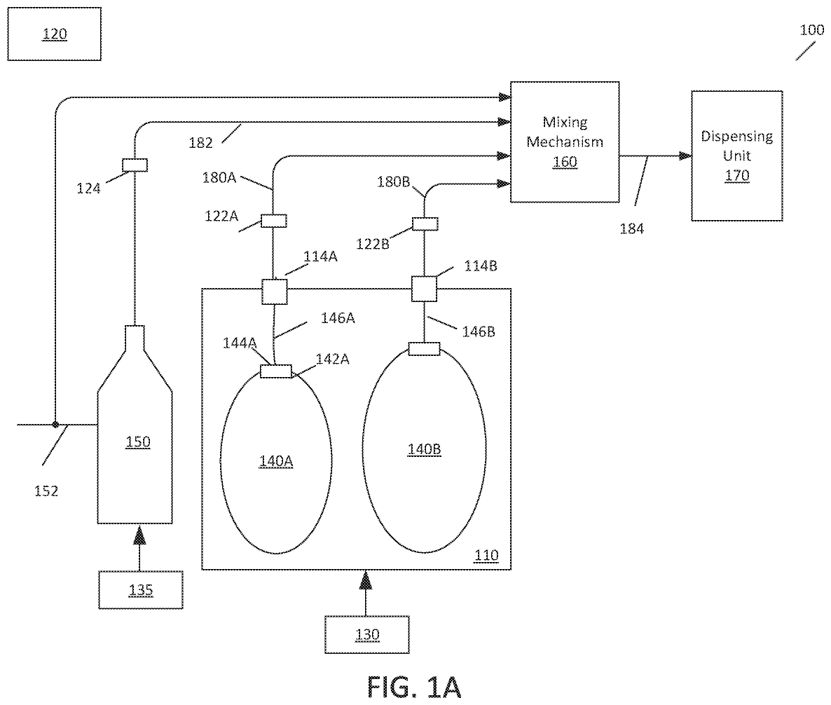

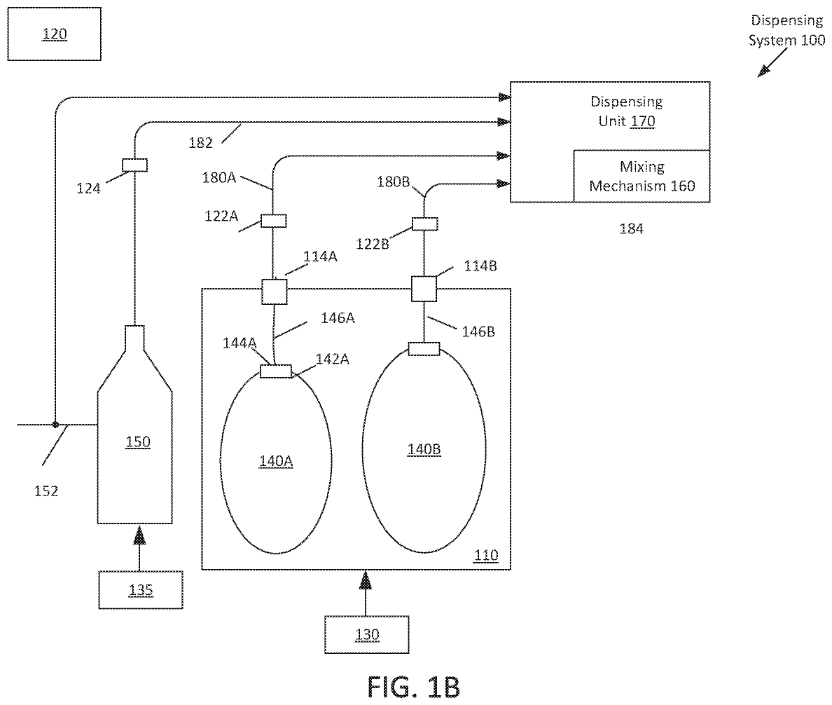

FIG. 1A is an illustrative diagram of a dispensing system 100 capable of re-alcoholizing, storing, preserving, managing, and selectively dispensing beverages or in some embodiments. The dispensing system 100 includes a pressurized canister/pressurized container 110, a control system 120, a controllable pressure system 130, a carbonation component 135, an air-tight container 150, a mixing mechanism 160, and a dispensing unit 170.

In some embodiments, the dispensing system 100 may include a temperature control system that maintains one or more components of the dispensing system 100 at a particular temperature or a range of temperatures. For example, dispensing systems 1900 and 1902 of FIG. 19 may be a dispensing system capable of re-alcoholizing, storing, preserving, managing, and selectively dispensing beverages, including refrigeration components. The dispensing system 1900 may be a standalone kiosk that dispenses beverages. For example, the dispensing system 1900 may be a self-service stationary dispenser pour unit (e.g., a kiosk such as that depicted in FIG. 19, where individual customers can be pre-authenticated and pre-authorized to operate the self-service dispenser pour units.

In some embodiments, the pressurized container 110 includes compressible liquid containers 140A and 140B (individually, collectively, compressible container 140). The compressible liquid container 140A may contain liquids or beverages such as beer concentrate (e.g., dehydrated beer). In one example, beer concentrate is a beer that has been brewed through a process to remove most of its water. The concentrate typically has less water than the original beer (e.g., less than half the volume of the original beer) but has a high alcohol content. When ready to drink, water and pure alcohol can be added to the concentrate before bottling or serving. The process may be repeated. In one example, the compressible liquid container 140B contains vodka. The vodka may be mixed with beer concentrate (e.g., in a mixing chamber or in a glass as liquids from compressible liquid containers 140A and B are dispelled in a glass) to rehydrate or re-alcoholize the beer concentrate to create beer for a consumer. In some embodiments, the compressible liquid container 140B contains malt syrup, which may be created by infusing malt with hot water; the malt or some other grain may provide sugar which may be used in brewing and/or preparing the beer.

The compressible container 140 may include a volume interface (e.g., locking mechanism) for accessing the liquid stored therein that enables a sealed/airtight connection to a releasable coupling that, in turn, couples the compressible container to a conduit. In one example, each compressible liquid container 140A includes a volume interface 142A (e.g., a nozzle or equivalent) for accessing the liquid stored therein. The volume interface 142A, may be configured to create a sealed/airtight connection to a releasable coupling 144A, that in turn couples the compressible liquid container 140A to a liquid transport conduit 146A. In one example, the volume interface 142A may include a releasable sealed connector element operable to form a releasable connection with the liquid transport conduit 146A so that the liquid transport conduit 146A can be readily disconnected if replacement of either component is necessary. The sealed connector element of the releasable coupling 144A may include a releasable adaptive pressurized filling that increases in strength and reliability in response to an increase in the pressure that is exerted in the dispensing system 400 (e.g., such as a pressurized “O-Ring” fitting).

In some embodiments, the liquid transport conduit 146A may couple the compressible liquid container 140A to a pressurized container interface 114A. The pressurized container interface 114A may be positioned, sized, and configured to align with and “plug in” or otherwise securely coupled to the corresponding pressurization and liquid delivery conduits when placed into a correspondingly configured “docking station” or equivalent. The pressurized container interface 114A may include 1-way check valves (or a combination control and 1-way check valves). While the liquid transport conduits 146A, 146B, 180A, 180B, and 182 may be of any sterile materials, they may be composed of flexible material that enables the dispensing system 100 to take advantage of the “hammer effect” to increase the speed of the liquid being dispensed therethrough.

The various conduits utilized in connection with the dispensing system 100 may comprise reliable, flexible tubing or equivalent. The various conduits may be composed of many materials, including, for example, plastic (and related materials such as polymers, etc.) or metal. In some embodiments, many or all conduits utilized in the dispensing system 100 may have uniform characteristics, whether employed for pressurization or for liquid transport functions (in which case, when used for beverage dispensing, the conduits are composed of non-reactive food-safe materials)—thus, simplifying the dispensing system 100 maintenance and upkeep. In various embodiments, replacement conduits may be readily cut and deployed as needed.

In some embodiments, the control system 120 controls various aspects of the dispensing system 100. In one example, the control system 120 controls features of the dispensing system 100 (e.g., using the dispensing profile(s)), such as the amount of pressure applied to the pressurized container/cartridge, temperature, dispensing profiles, user profiles, solenoid valves, and/or dispense pour units.

In some embodiments, when a user places a compressible container (such as WinB products) into the pressurized container 110, the user may provide the control system with information to identify the contents of the compressible container. For example, the user may select an ingredient (or combination of ingredients) from a particular list of options to indicate the contents of the compressible container. In some embodiments, the user may scan a barcode, QR code, RFID code, and/or the like and provide a code identifier to the control system. The control system may then identify the contents of the compressible container based on the provided code identifier. In some embodiments, the control system may identify one or more conduits and/or one or more valves that are coupled (or to be coupled) to the particular compressible container.

The control system may modify any number of dispensing profiles based on the contents of the new compressible container. A dispensing profile may indicate which solenoids need to be opened and for how long they need to be open to enable the flow of product from one or more compressible containers in the pressurized environment into the appropriate container (e.g., wine glass, glass, or mug). For example, a beer margarita dispensing profile may be linked or associated with a particular compressible container as well as a valve coupled to the flow path of the contents of the particular compressible container. As such, the control system may adjust instructions to the dispensing profile to identify the relevant valve and/or recalculate any predetermined times to keep the valve open based on the diameter of the conduits (and other components) in the flow path between the compressible container and the dispensing system (e.g., nozzles to dispense the product).

In some embodiments, a user may identify and provide properties of the contents of the compressible container to the control system 120. Properties may include, for example, the type of compressible container contents (e.g., beer concentrate, vodka, coffee, soft serve, or the like) and/or the viscosity of the beverage/liquid. Based on the properties, the control system may generate a new dispensing profile or may adjust any existing dispensing profiles based on the new information and the user of ingredients associated with the information provided by the user. In some embodiments, the user may provide temperature constraints for the content to be served (for example, the soft serve may need to be kept below a certain temperature).

In some embodiments, the control system 120 may include pre-defined recipes for beverages and food items. Each pre-defined recipe may specify an amount of each of the ingredients of the beverage or food item. For example, a pre-defined recipe may define an amount of beer concentrate, an amount of alcohol, and/or an amount of carbonation for a particular beer serving. There may be many different pre-defined recipes. For example, there may be different pre-defined recipes for each different type of beer, beer and alcohol pairing, beer and carbonation pairing, and/or beer-serving.

In some embodiments, each pre-defined recipe may specify an order in which to add or mix the ingredients. The control system 120 may utilize the pre-defined recipe to determine parameters (e.g., to be included in a dispensing profile), such as a period of time to keep a valve associated with a compressible container containing the ingredient open. The control system 120 may determine the period of time to open and/or close a valve based on any number of factors including, but not limited to, viscosity of the liquid to be dispensed from the compressible container, the diameter of the conduit coupled between the compressible container and the controllable valve, and/or the temperature of the dispensing system. One or more of these properties may affect the period of time with which the controllable valve needs to be opened to allow a sufficient measure of liquid to flow through the liquid transport conduit to make the pre-defined recipe or blending profile. In some embodiments, the control system may utilize a pre-defined recipe to determine parameters for an amount of pressure to apply to the pressurized container/cartridge to control the controllable pressure system to dispense the ingredient.

In some embodiments, the control system 120 may selectively unlock or lock one or more valves (e.g., open or close the valves of transport conduits) of the dispensing system 100 by selectively activating (e.g., opening or closing) one or more solenoids, such as the solenoids 122A, 122B, and 124. In some embodiments, the parameters may include an amount of time one or more solenoids, such as solenoids 122A and 122B of the system are open (e.g., selectively unlocked). In some embodiments, the parameters may include an amount of time one or more solenoids of the system are closed (e.g., selectively locked).

In some embodiments, the control system 120 is controllable by a mobile device with a corresponding software application including a graphical user interface. The software application may receive a request from a user of the mobile device to dispense a particular drink. In some embodiments, the control system 120 is controllable by a user interface coupled with the dispensing system.

In one example, the control system 120 may include a local control system. The local control system includes a graphics display unit, such as a touchscreen monitor. For example, the dispensing systems 1900 and 1902 include display units 1904 and 1906, which may be touchscreen monitors.

In various embodiments, the controllable pressure system 130 is coupled to the pressurized container 110. The controllable pressure system 130 is selected and configured to provide direct pressurization to the compressible container stored therein to generate and maintain the pressurized environment within the necessary/desired parameters.

The controllable pressure system 130 may be controllable by a mobile device with a corresponding software application comprising a graphical user interface installed thereon. The software application may be a part of the beverage management system (BMS) and/or on a remote digital device such as a smartphone, table, or the like.

The software application may receive a request from a user of the mobile device to dispense a particular drink. The software application may send a digital signal to the controllable pressure system 130 to (e.g., briefly) increase the level of pressure in a pressurized environment within the pressurized container 110 for all or a portion of the duration of a dispensing period to provide additional force and velocity to the liquid being expelled from the compressible container stored within the pressurized container 110.

The optional carbonation component 135 may be operable to selectively add carbonation to a beverage being dispensed. Carbonation may be accomplished by injecting a carbonation medium (for example, CO₂ from a carbonation source, such as a CO₂ tank coupled to the mixing mechanism 160). For example, the carbonation component 135 may be or include a CO₂ tank to provide carbonation to a liquid contained in the air-tight container 150. In one example, the air-tight container 150 includes filtered and/or distilled water. In some embodiments, the air-tight container 150 may receive tap water or filtered water through a water line 152. In some embodiments, the air-tight container 150 may receive carbon dioxide from the carbonation component 135. The liquid in the air-tight container 150 may be carbonized by the gases received from the carbonation component 135. The control system 120 may determine the amount of carbon dioxide gas to send to the air-tight container 150 based on a number of factors including, but not limited to, a quantity and temperature of the carbonated beverage to be dispensed by the dispensing system 100. For example, a colder beverage may require additional carbonation or more CO₂ to achieve the same carbonation compared to a warmer beverage. As a result, a beer that is served at a colder temperature may require more CO₂ to achieve the same beer head compared to a beer that is served at a warmer temperature. In some embodiments, a water line 152 may provide distilled and/or filtered water to the air-tight container 150. In various embodiments, the control system 120 may be configured to control the amount of carbonation based on a temperature of the beverage to be dispensed (e.g., based, in part, on a pre-defined recipe of the beverage to be dispensed).

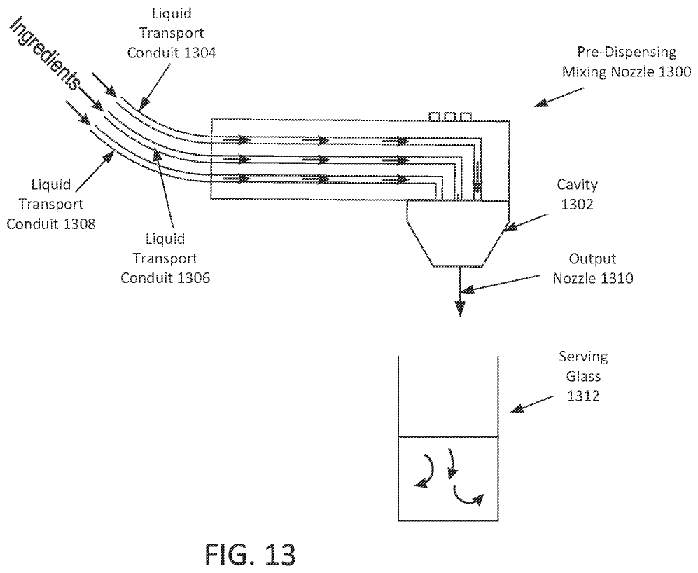

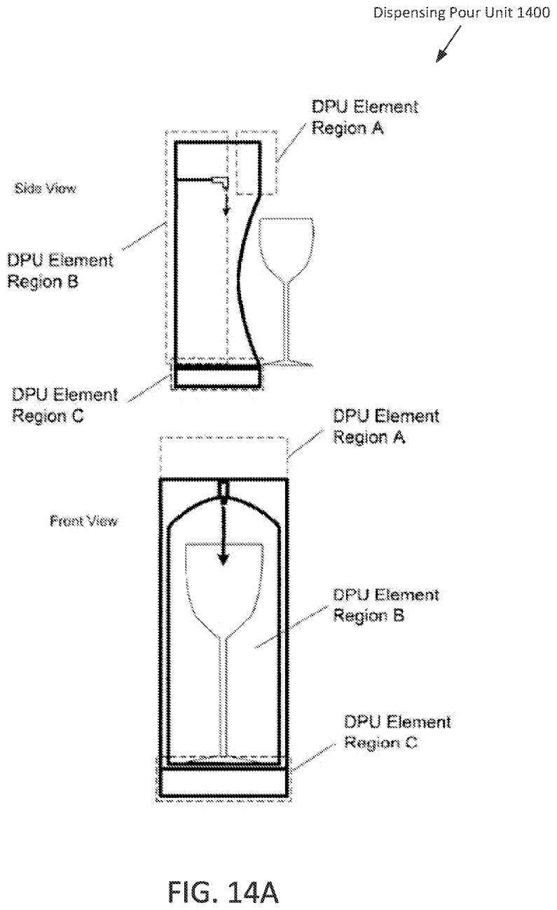

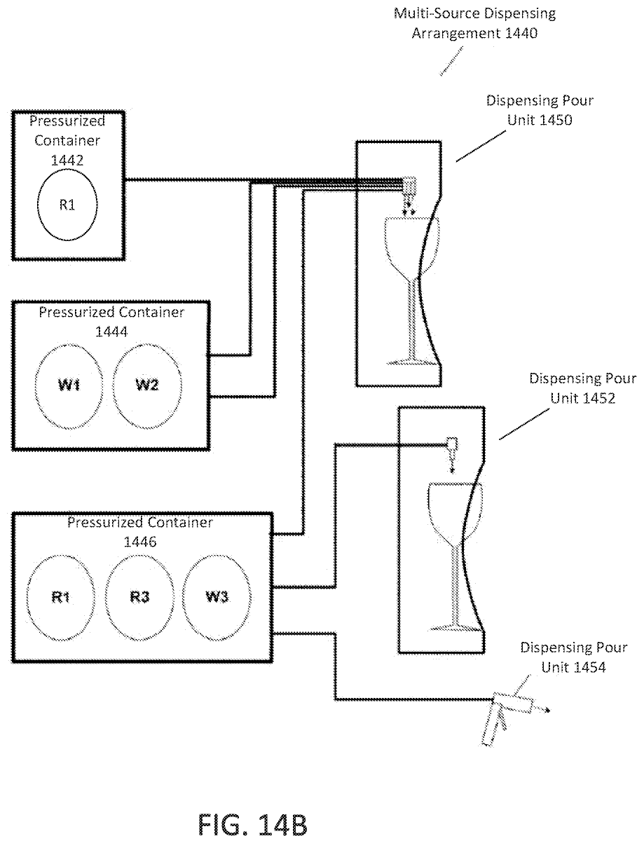

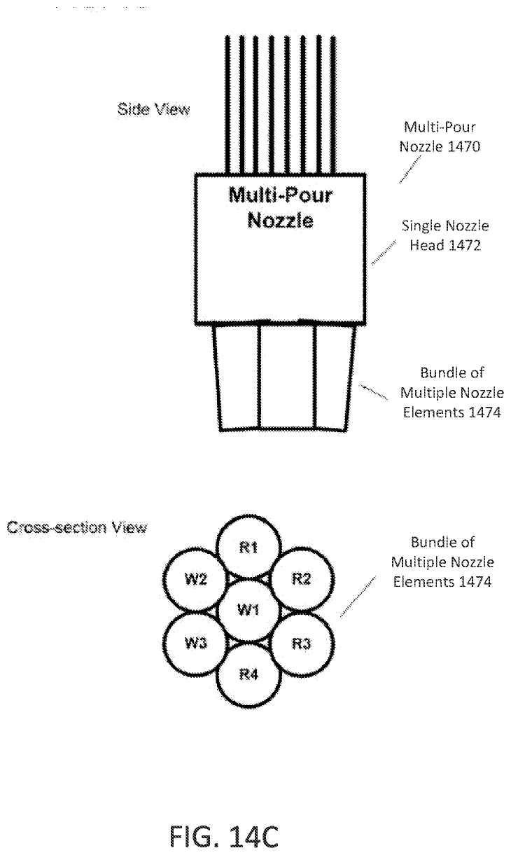

The liquid transport conduits 180A, 180B, and 182 may be coupled to the mixing mechanism 160. In one example, the mixing mechanism 160 receives tap or filtered water from the water line 152. In some examples, one or more of the mixing mechanisms 160 may include venturi systems, mixing chambers, nozzles of different sizes, and/or the like. In some embodiments, the mixing mechanism 160 includes a mixing tube such as a static mixing tube. In one example, the mixing mechanism 160 may include a mix propeller, an in-line mixing chamber, a vortex generator apparatus, and an ultrasonic homogenizer. The dispensing unit 170 may include some or all of the components of the dispensing pour units of FIG. 13 and FIG. 14A through 14C.

In another example, the mixing mechanism may be a part of the dispensing unit 170, which can be seen in dispensing unit 170 of FIG. 1B. An example of a mixing mechanism which is a part of the dispensing unit 170 can be seen in FIG. 13.

A liquid transport conduit 184 may be coupled between the mixing mechanism 160 and the dispensing unit 170 to transport liquids from the mixing mechanism 160 to a dispensing unit. In some embodiments, the dispensing unit 170 includes a manual interface that enables a customer or server (e.g., waiter or bartender) to dispense or trigger dispending of a beverage. In one example, the dispensing unit 170 includes a tap handles and faucets similar to those of traditional bars, restaurants, and/or breweries. In this example, the dispensing system 100 may provide beer (e.g., from dehydrated beer and alcohol has discussed herein) and the dispensing unit 170 includes one or more pull arms similar to that used to serve a beer on draft in a brewery.

An example of this can be seen in FIG. 19, dispensing systems 1900 (e.g., a kiosk type of dispensing system), including tap handles 1908 and faucets 1910. A serving glass may be placed under one of the faucets 1910. A beverage may be dispensed from the dispensing systems 1900 when a user places a serving glass under the faucets 1910. It will be appreciated that the dispensing system 1900 may utilize any control system (e.g., manual handles, spigots, or control panels).

In some embodiments, the dispensing unit 170 has some or all of the components of the dispensing pour units of FIG. 14A through 14C.

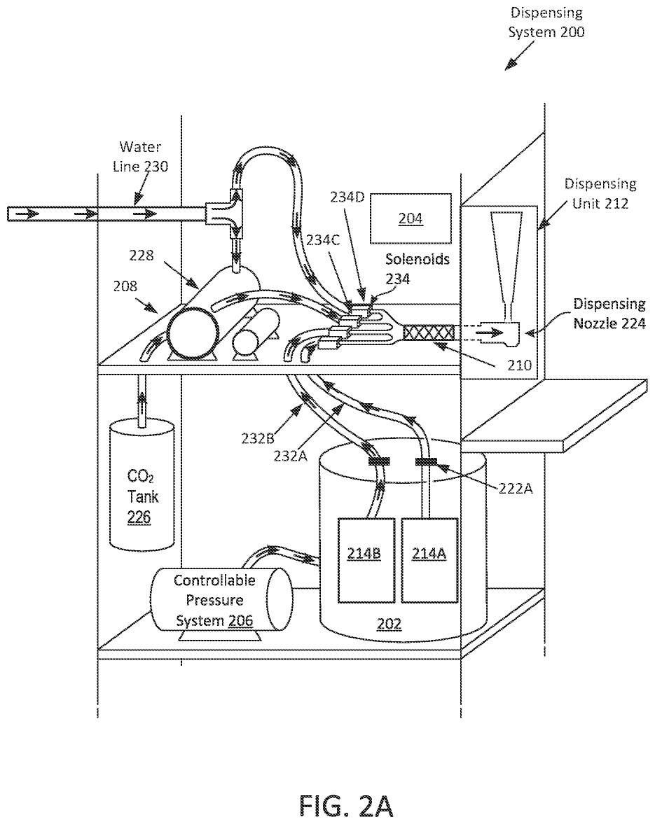

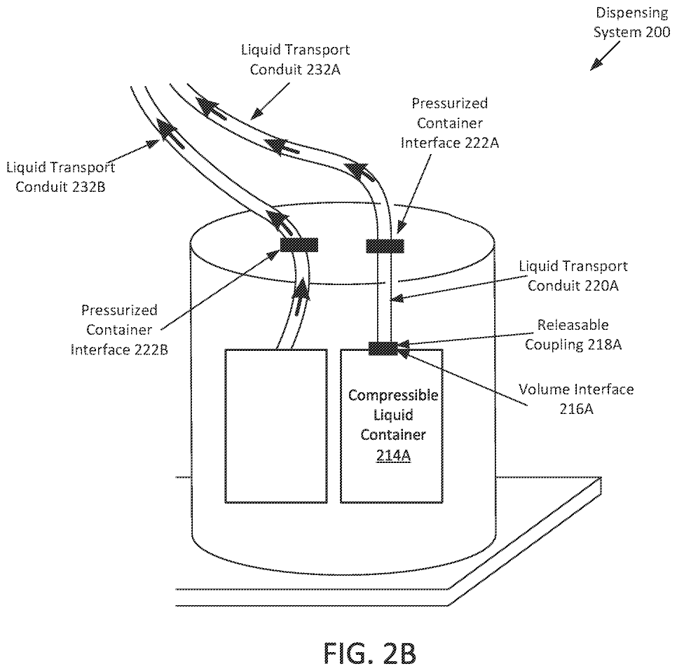

FIG. 2A is an illustrative diagram of a dispensing system 200 capable of re-alcoholizing, storing, preserving, managing, and selectively dispensing beverages or in some embodiments. The dispensing system 200 includes a pressurized container 202, a dispensing control system 204, a controllable pressure system 206, a carbonation system 208, a mixing mechanism 210, and a dispensing unit 212.

In some embodiments, the dispensing system 200 may include a temperature control system that maintains one or more components of the dispensing system 200 at a particular temperature or a range of temperatures. For example, dispensing systems 1900 and 1902 of FIG. 19 may be a dispensing system capable of re-alcoholizing, storing, preserving, managing, and/or selectively dispensing beverages may include refrigeration components.

The pressurized container 202 includes compressible liquid containers 214A and 214B (individually, collectively, compressible liquid container 214). In some embodiments, the compressible liquid container 214A contains liquids or beverages such as beer concentrate (e.g., dehydrated beer). Beer concentrate may be created using fermentation and then alcohol may be removed from the beer. Beer may be at least 90% water, with the remaining 10% including ethanol and other elements. Depending on the type or brand of the beer, the ratio between water and the remaining components may vary. In one example, beer concentrate is comprised of 20% of the water of beer. Predefined recipes (e.g., profiles) discussed herein may include different types of beer, at different serving sizes, and at different alcohol percentages.

In one example, the compressible liquid container 214B contains vodka. In this example, vodka may be mixed with beer concentrate (e.g., in a mixing chamber or in a glass as liquids from compressible liquid containers 214A and 214B are dispelled in a glass) to rehydrate or re-alcoholize the beer concentrate to create beer. In some embodiments, a compressible liquid container 214B contains malt syrup which may be created by infusing malt with hot water. Malt or some other grain may provide sugar to a drink (e.g., beer).

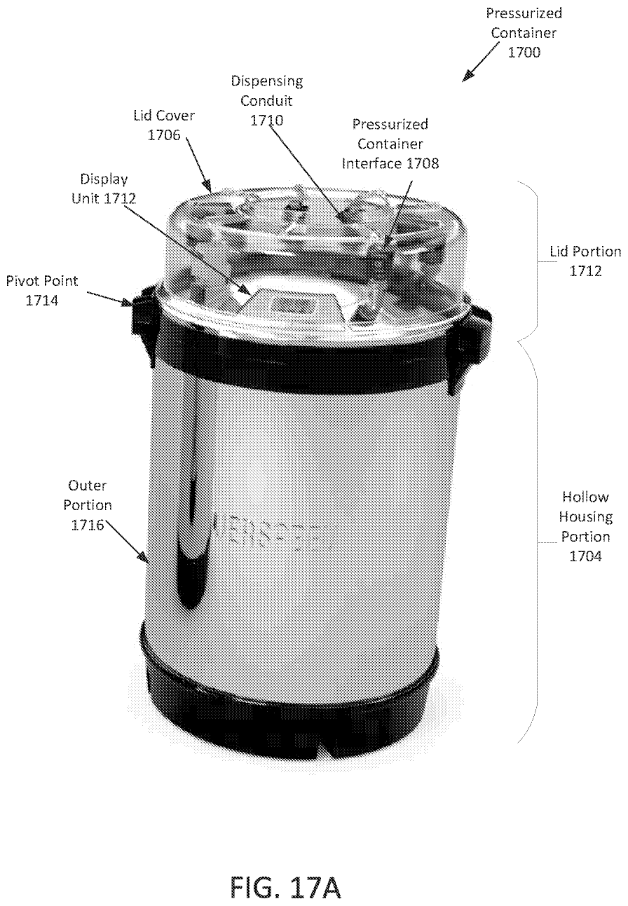

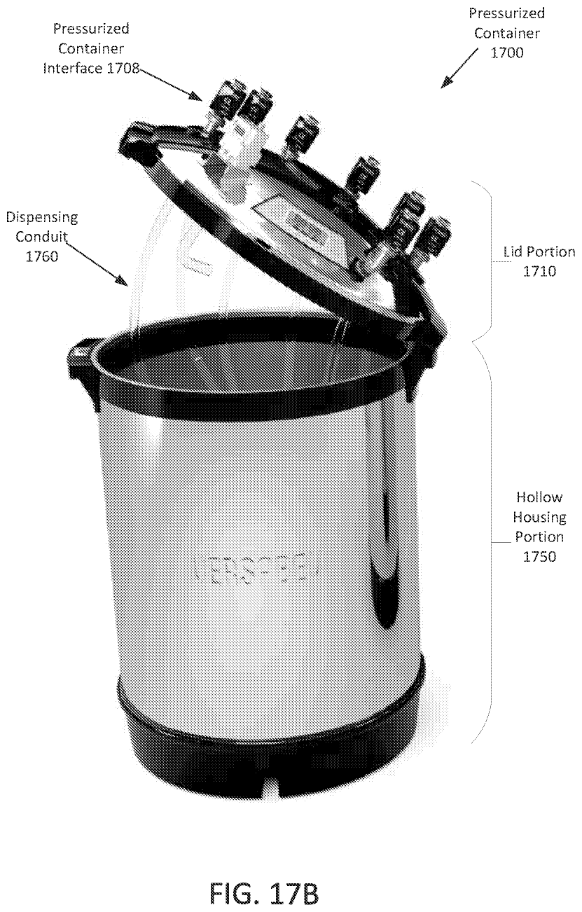

In some embodiments, different compressible liquid containers 214 in the pressurized container 202 are kept at different temperatures. For example, the pressurized container 202 includes compartments (e.g., hot plates and/or cold plates) which allow one or more compressible liquid container 214 to be kept at a particular temperature or a particular range of temperature that may or may not be different from another compartment. Beer and mix drinks may be served at different temperatures, so a beer concentrate may be kept at a temperature that is lower than that of vodka or other hard liquors. An example of the pressurized container 202 may be seen in FIGS. 17A and 17B. In some embodiments, the compressible liquid containers 214 within a pressurized container 202 may be kept at a particular temperature or range of temperatures while other compressible liquid containers 214 within a different pressurized container 202 may be kept at a different temperature or a different range of temperatures.

In some embodiments, the pressurized container 202 may be divided such that one or more compressible containers may be within a divided portion. The divided portion may be heated, cooled, or both independent of other divided portions (e.g., such that one compressible liquid container 214A may be cooled while another compressible liquid container 214B may not be affected by the cooling of compressible liquid container 214A). Each divided portion may be temperature controlled independently of other divided portions. In some embodiments, different divided portions may be independently cooled. In various embodiments, different divided portions may be independently heated. In some embodiments, different divided portions may be independently cooled or heated. Each divided portion may include heating elements and/or cooling elements for temperature regulation or control.

In various embodiments, the pressurized container is not divided but there may be temperature elements for active or passive cooling, heating, or both within the pressurized container.

In some embodiments, the compressible liquid container 214 includes a volume interface (e.g., locking mechanism) for accessing the liquid stored therein, configured for a sealed/airtight connection to a releasable coupling that, in turn, couples their corresponding connects the compressible container to a conduit. FIG. 2B shows the compressible liquid container 214 in further detail. For example, the compressible liquid containers 214A includes a volume interface 216A (e.g., a nozzle or equivalent) for accessing the liquid stored therein, configured for a sealed/airtight connection to a releasable coupling 218A, that in turn couples to the compressible liquid container 214A to a liquid transport conduit 220A. In one example, the volume interface 216A may include a releasable sealed connector element operable to form a releasable connection with the conduit 220A, so that the conduit 220A can be readily disconnected if replacement or either component is necessary. The sealed connector element of the releasable coupling 218A may include a releasable adaptive pressurized filling that increases in strength and reliability in response to an increase in the pressure that is exerted in the dispensing system 400 (e.g., such as a pressurized “O-Ring” fitting).

The conduit 220A may couple to the compressible liquid container 214A to a pressurized container interface 222A. The pressurized container interface 222A may be positioned, sized, and configured to align with and “plug in,” or otherwise securely couple to the corresponding pressurization and liquid delivery conduits when placed into a correspondingly configured “docking station” or equivalent. The pressurized container interface 222A may include 1-way check valves (or combination control and 1-way check valves). While the liquid transport conduits 220A may be of any sterile materials, they may be composed of flexible material that enable the dispensing system 200 to take advantage of the “hammer effect” to increase the speed of the liquid being dispensed therethrough.

The dispensing control system 204 controls various aspects of the dispensing system 200. In some embodiments, the dispensing control system 204 controls features of the dispensing system 200 (e.g., using dispensing profile(s)), such as the amount of pressure applied to the pressurized container/cartridge, temperature, dispensing profiles, user profiles, solenoid valves, and dispense pour units. In one example, the control system 120 may control features of the dispensing system 200 based on additional information regarding a particular user such as the particular user's previous orders from dispensing system 200 and physical characteristics of the particular user such as weight and height.

In some embodiments, the dispensing control system 204 is controllable by a mobile device with a corresponding software application including a graphical user interface. The software application may receive a request from a user of the mobile device to dispense a particular drink. In some embodiments, the dispensing control system 204 is additionally or alternatively controllable by a user interface coupled the dispensing system.

The controllable pressure system 206 may be controllable by the dispensing control system 204. The controllable pressure system 206 may provide pressurization to the compressible liquid volume stored in the pressurized container 202 and maintain the pressurized environment within the necessary/desired parameters.

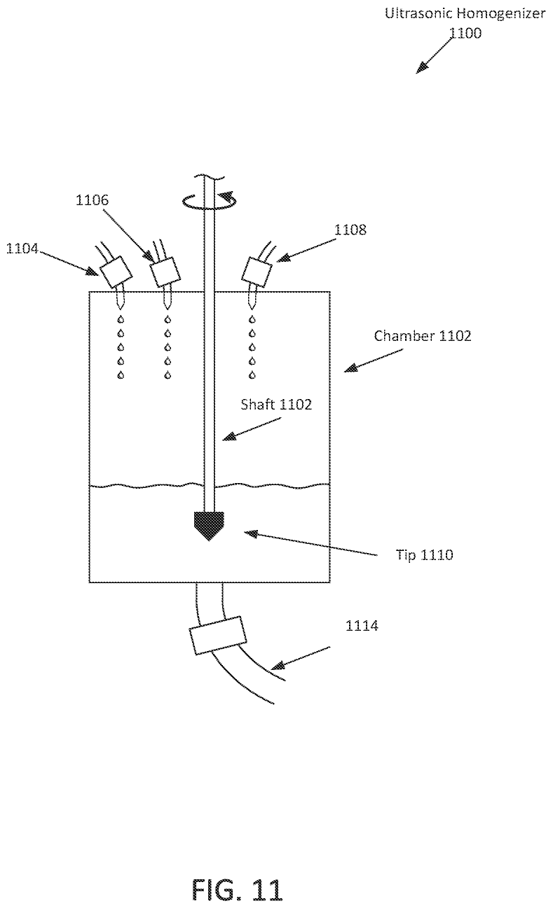

In some embodiments, the controllable pressure system 206 is controllable by a mobile device with a corresponding software application including a graphical user interface. The software application may receive a request from a user of the mobile device to dispense a particular drink. In some embodiments, the controllable pressure system 206 is controllable by a user interface coupled the dispensing system. In one example, a display unit, such as a touchscreen may be mounted in an area above a dispensing nozzle 224 of the dispensing unit 212. More details regarding the dispensing unit 212 will be discussed regarding FIGS. 11 through 15.

In some embodiments, the controllable pressure system 206 may include pre-defined recipes for beverages and food items using one or more of the compressible containers 214. The pre-defined recipe may specify an amount of each of the ingredients of the beverage or food item. The pre-defined recipe may also include an order in which to add or mix the ingredients. The dispensing control system 204 may utilize the pre-defined recipe to determine parameters (e.g., to be included in a beverage profile) such as a period of time and an amount of pressure to apply to the pressurized canister/cartridge by a controllable pressure system to allow liquid to be selectively dispensed through a normally locked dispensing conduit connected to the pressurized canister/cartridge. The dispensing control system 204 may determine the period of time based on any number of factors, including, but not limited to, viscosity of the liquid contained within the compressible container, the diameter of the conduit coupled between the compressible container and the controllable valve, and/or the temperature of the dispensing system. One or more of these properties may affect the period of time with which the controllable valve needs to be opened to allow a sufficient measure of liquid to flow through the liquid transport conduit to make the pre-defined recipe or blending profile.

The optional carbonation system 208 selectively adds carbonation to a beverage being dispensed. Carbonation may be accomplished by injecting a carbonation medium (e.g., CO₂) from a carbonation source, such as a CO₂ tank 226 coupled to a carbonation pump 228. The carbonation pump 228 infuses carbon dioxide gas under high pressure into a liquid, such as water or filtered water via water line 230, creating sparkling or carbonated water. The dispensing control system 204 may determine the amount of carbon dioxide gas that the CO₂ tank 226 should send to the carbonation pump 228 based on any number of factors including, but not limited to, a quantity and/or temperature of the carbonated beverage to be dispensed by the dispensing system 200. For example, a colder beverage may require more carbonation (e.g., more CO₂) to achieve the same carbonation as compared to a warmer beverage. As a result, a beer that is served at a colder temperature may require more CO₂ to achieve the same beer head compared to a beer that is served at a warmer temperature. In some embodiments, the water line 230 may provide distilled and/or filtered water to the carbonation pump 228. The water line 230 may be coupled to the mixing mechanism 210 via a solenoid valve 234D.

Liquid transport conduits 232A and 232B (individually, liquid transport conduit 232 collectively) couple compressible liquid containers 214A and 214B to pressurized container interfaces 222A and 222B, respectively. The pressurized container interfaces 222A and 222B may be positioned, sized, and configured to align with and “plug in” or otherwise securely couple to the corresponding pressurization and liquid delivery conduits when placed into a correspondingly configured “docking station” or equivalent. In some embodiments, pressurized container interfaces may have 1-way check valves (or combination control and 1-way check valves).

The liquid transport conduit 232 may couple the compressible liquid container 214 stored within the pressurized container 202 to a mixing mechanism 210 via solenoid valves 234. For example, solenoid valve 234A may be configured to allow the contents of the compressible liquid container 214A to flow to the mixing mechanism 210. In one example, when opened, a solenoid valve 234C selectively adds carbonation to a beverage being mixed by the mixing mechanism 210. A solenoid valve 234D selectively adds water or filtered water via the water line 230.

It will be appreciated tha the mixing mechanism 210 is optional. In some embodiments, there is no mixing mechanism. In other embodiments, the mixing mechanism is in the dispensing system (e.g., mixing happens at the nozzle or in a chamber before the nozzle that dispenses the liquid(s)).

In some embodiments, a hopper attachment (not shown) may be coupled to the mixing mechanism 210. The hopper attachment may store powdered or granulated beer. The hopper attachment may provide powdered or granulated beer to the mixing mechanism 210. The powdered or granulated beer may be rehydrated by mixing it with water, filtered water, and/or alcohol (e.g., vodka) to produce alcoholic beer. Powdered beer is dehydrated beer processed into powder form. In one example, beer can be at least 90% by weight, by removing the water, the resultant dehydrated beer powder may weigh 10% of the hydrated beer. The remaining 10% comprises other elements of beer including, but not limited to, malt, hops, yeast, and alcohol. This reduction in weight may extend the shelf life of the product, reduces the carbon footprint required to transport and store the beverage, and may reduce weight in shipping.

The various conduits utilized in connection with the dispensing system 400 may comprise reliable, flexible tubing or equivalent. In one example, the flexible tubing may be composed of plastic, polymers, metal(s), and/or the like. In some embodiments, many or all conduits utilized in the dispensing system 400 have uniform characteristics, whether employed for pressurization or for liquid transport functions. In some embodiments, the conduits are composed of non-reactive food-safe materials for transporting consumables (e.g., beverages, desserts, semi-soft consumables, dairy products, and/or the like). In various embodiments, replacement conduits may be readily cut and deployed as needed.

The optional mixing mechanism 210 may include structures and/or cavities to assist with mixing. In various examples, the mixing mechanism 210 may include a mix propeller, an in-line mixing chamber, a vortex generator apparatus, and/or an ultrasonic homogenizer. In some embodiments, the mixing mechanism 210 may be positioned in a temperature-controlled environment. The temperature-controlled environment may be passive (such as a cellar/basement), active (such as a refrigerated housing (or refrigerated jacketing or coils positioned around the mixing mechanism), or a cold plate (or equivalent), or ice or equivalent freezable cold elements, positioned proximally to the mixing mechanism, or a combination of one or more of the above.

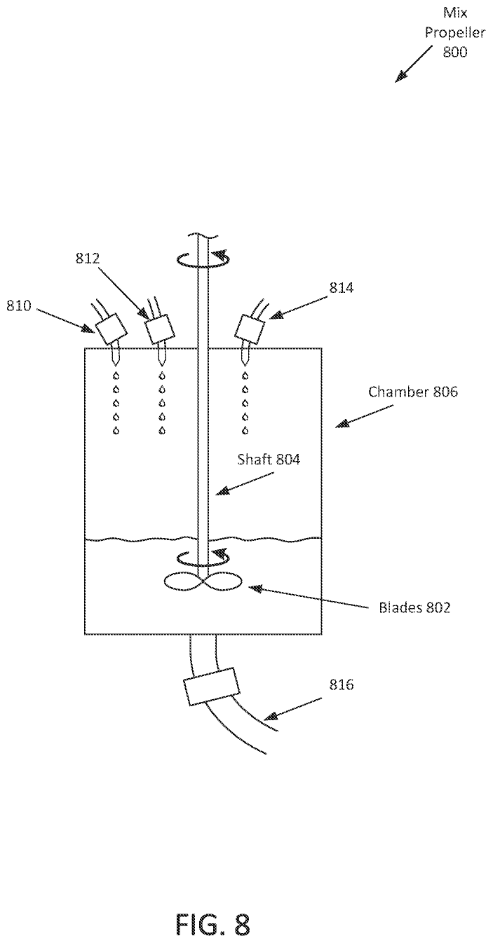

An example mix propeller 800 can be seen in FIG. 8. The mix propeller 800 includes blades 802, shaft 804, and a chamber 806. One or more liquids are introduced to the mix propeller 800 via liquid transport conduits 810, 812, and 814. A motor (not shown) coupled to the shaft 804 spins the blades 802 to mix the liquids within the chamber 806.

The mix propeller 800 may function like a blender where external power will drive the shaft 804 to agitate and homogenize the ingredients. All ingredients may be added into the mixing chamber to be mixed. The mixed beverage may be dispensed to the dispensing unit 212 via a liquid transport conduit 816. The liquid transport conduit 816 may be coupled to the dispensing unit 212 of FIG. 2A.

In some embodiments, the dispensing unit 212 includes tap handles and faucets similar to those of traditional bars, restaurants, and breweries. An example of this can be seen in FIG. 19, dispensing systems 1900, including tap handles 1908 and faucets 1910. In one example, a serving glass may be placed under one of the faucets 1910. A beverage may be dispensed from the dispensing systems 1900 when a user places a serving glass under the faucets 1910.

Chambers of mix propellers may have a larger capacity compared to other types of mixing mechanisms. However, agitation of the liquid may cause excess foaming, and there is a higher chance of potential parts or components to break down due to the moving parts. In some embodiments, the mix propeller 800 may be easily disassembled and cleaned.

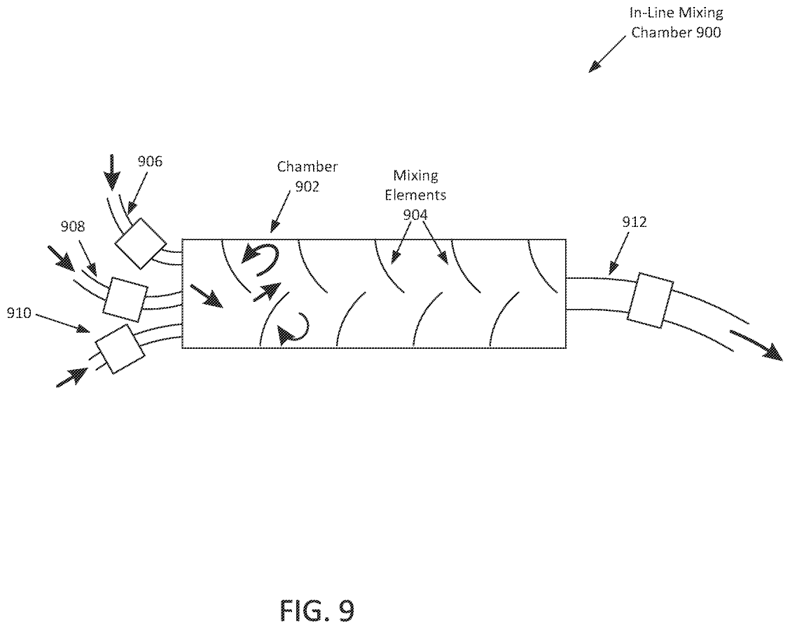

An example in line mixing chamber 900 can be seen in FIG. 9. In this example, ingredients are introduced to the chamber 902 of the line mixing chamber 900. One or more liquids and/or materials (e.g., flavorings, semi-soft materials, or the like) may be introduced to the chamber 902 via liquid transport conduits 906, 908, and 910 and/or outside lines. One or more liquids introduced to the line mixing chamber 900 may be mixed by mixing elements 904. In some embodiments, the mixing elements 904 may be fins, dimples, or a wire coil coupled to an interior or inside of the chamber 902.

In some embodiments, the mixing chamber 900 includes a portal that may be opened by the user to add additional flavorings, liquids, and materials for the consumer. In one example, a user may select a beverage profile from an interface of the dispensing system 100. The Beveridge profile may be associated with a predefined recipe for a particular beverage. The control system 120 may trigger any number of solenoids to release the right amounts of liquid from one or more of the compressible containers to enable a predetermined amount of the one or more liquids into a mixing chamber. Before, during, or after the liquids are in the mixing chamber, the user may open the portal to the mixing chamber 900 and add additional flavorings, materials, liquids, as desired. The materials in the mixing chamber 900 may then be mixed or blended as needed for the beverage which may be disposed thereafter. By enabling a user to add additional flavorings, flavorings, and or liquids, a greater number of recipes may be available to be dispensed, customizations that are personal to the consumer may be offered, or unique bespoke beverage options may be available.

In one example, the line mixing chamber 900 may be placed inside the pressurized container, such as the pressurized container 110 of FIG. 1A or the pressurized container 202 of FIG. 2A.

Liquids introduced to the chamber 902 through the liquid transport conduits 906, 908, and 910 may be pushed through the mixing elements 904 of the chamber 902. The mixing elements 904 increase the surface area of the inside of the chamber 902. This causes turbulence in the liquid and mixes the ingredients. The mixed beverage may be dispensed to the dispensing unit 212 via a liquid transport conduit 912. In some embodiments, the chamber 902 may include a portal or conduit that enables the user (e.g., server) to provide liquids, flavorings, and/or materials in manner similar to that discussed above with regard to the mixing chamber 900.

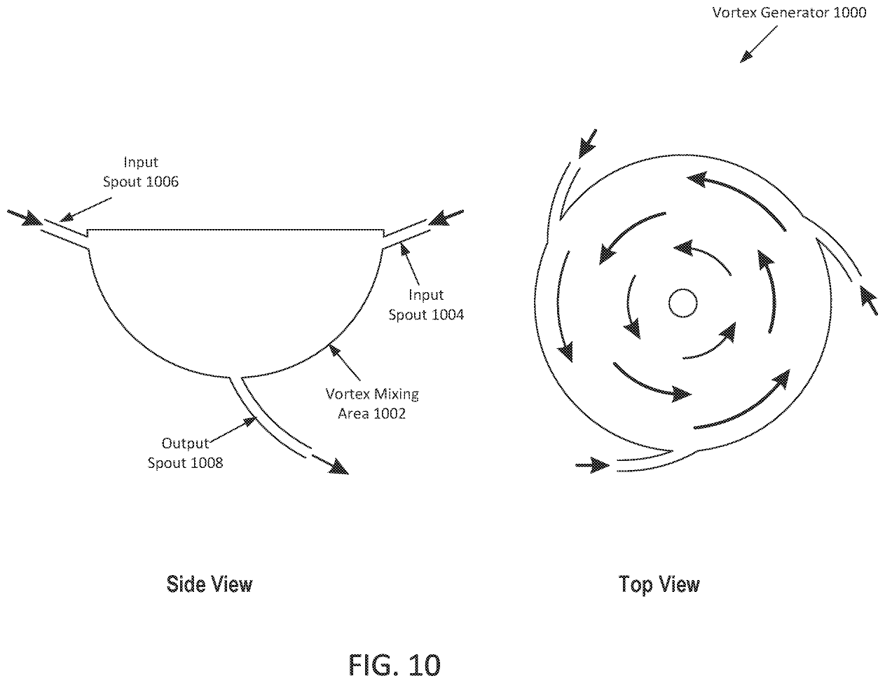

An example of a vortex generator 1000 can be seen in FIG. 10. Ingredients may be introduced to a vortex mixing area 1002 via input spouts 1004 and 1006. A liquid transport conduit may be coupled to each of the input spouts 1004 and 1006 to transport liquid to the vortex generator 1000. As ingredients are introduced into the vortex mixing area 1002, a vortex is generated by the circular shape of the vortex mixing area 1002. In some embodiments, liquid ingredients are injected into the vortex mixing area 1002 at an angle to create the vortex. Ingredients swirl down the vortex mixing area 1002 towards an output spout 1008. A liquid transport conduit may be coupled to the input spouts 1006 to the dispensing unit 212. In some embodiments, a vortex generator can be easily cleaned by flushing the vortex mixing area 1002 with water.

The vortex generator 1000 may be positioned in any number of places. In one example, the vortex generator 1000 is placed inside the pressurized container, such as the pressurized container 110 of FIG. 1A or the pressurized container 202 of FIG. 2A.

An example of an ultrasonic homogenizer 1100 can be seen in FIG. 11. Ingredients may be introduced to a chamber 1102. In one example, one or more liquids are introduced to the chamber 1102 via liquid transport conduits 1104, 1106, and 1108. Vibrations in a tip 1110 of a shaft 1112 may cause ultrasonic energy (e.g., ultrasonic sound waves) to disrupt materials within the liquid in the chamber 1102. The vibrations generate pressure waves in the liquid, forming and collapsing bubbles. The collapse releases energy in the form of shock waves, breaking down particles and droplets within the liquid and mixes the ingredients. The mixed beverage may be dispensed to the dispensing unit 212 via a liquid transport conduit 1114.

A venturi system may be utilized to mix the liquids, solids, and/or semi-solids. A venturi system may include a constricted section to mix the liquids, solids, and/or semi-solids. The venturi system may use a venturi effect caused by cohesion and velocity to mix.

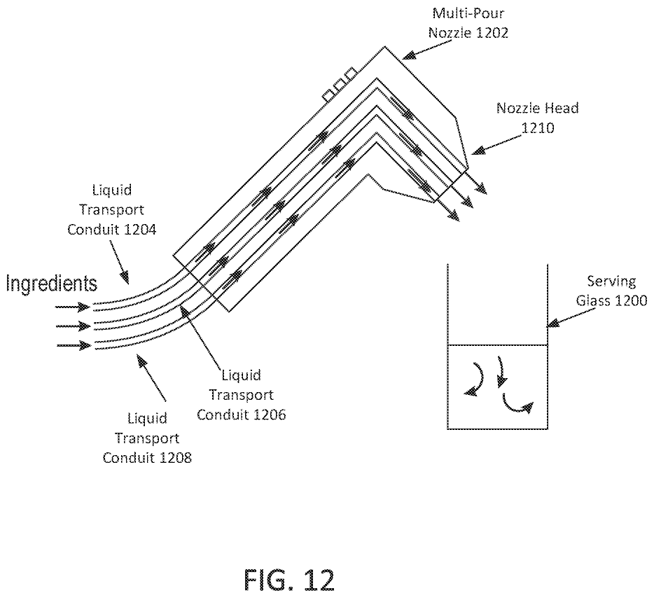

An example of a post-dispense injection injection can be seen in FIG. 12. The mixing mechanism is a serving glass 1200. In some embodiments, a multi-nozzle 1202 is a part of the dispensing unit 212 of FIG. 2A. The multi-nozzle 1202 enables the dispensing unit to dispense different beverages from multiple corresponding beverage sources contained within the pressurized container 202 of FIG. 2A.

In various embodiments, the multi-nozzle 1202, similar to that of a multi-pour nozzle 1470 shown in FIG. 14C, may be used. Liquid transport conduits 1204, 1206, and 1208, may be coupled to their respective solenoids to transport liquid to a nozzle head 1210. In this example, the nozzle head 1210 comprises a bundle of multiple nozzle elements disposed therein, to enable the dispensing pour unit to dispense different beverages from multiple corresponding beverage sources such as the pressurized container 202 or the carbonation system 208.

The dispensing control system 204 sends control signals to selectively open and close one or more solenoids corresponding to ingredients of a beverage based on a pre-defined dispensing profile. As the liquid from one or more of the liquid transport conduits 1204, 1206, and/or 1208 is dispensed into the serving glass 1200, the liquid(s) will mix.

In one example, the mixing mechanism is a pre-dispense mixing mechanism such as a pre-dispensing multi-nozzle 1300 of FIG. 13. In contrast to the post-dispense injection mechanism seen in FIG. 12, ingredients of the mixed beverage are mixed in a mixing cavity 1302. Ingredients enter the mixing cavity 1302 via liquid transport conduits 1304, 1306, and 1308. In some embodiments, the mixing cavity 1302 includes passive mixing elements, including, but not limited to fins, dimples, and/or a wire-coil coupled to an interior of the mixing cavity 1302, similar to that of the line mixing chamber 900 of FIG. 9. In one example, the mixing cavity 1302 includes helical internal structures to induce rotational and translational flow patterns to mix the liquid. The mixed beverage may be dispensed through an output nozzle 1310 to a serving glass 1312.

The various conduits utilized in connection with the dispensing system 200 may comprise reliable, flexible tubing or equivalent. In some embodiments, many or all conduits utilized in the dispensing system 200 may have uniform characteristics, whether employed for pressurization or for liquid transport functions.

In some embodiments, the dispensing system 200 includes a breathalyzer. A user may utilize the breathalyzer to determine their blood alcohol level or to provide guidance as to whether they can drive or order additional alcoholic beverages (e.g., at normal or lower recommended percentages of alcohol). In some embodiments, if the user's test results are above a particular threshold or limit, the dispensing system 200 may not allow another alcoholic beverage to be dispensed (e.g., the dispensing system 200 may provide water, carbonated water, soft drinks, and/or the like).

As discussed herein, the dispensing system 200 may utilize the results of the breathalyzer test to determine whether or not a particular user's requested beverage may be dispensed, or if the beverage needs to be modified such as, for example, decreasing the alcohol content of the requested beverage (e.g., because the particular user's blood alcohol concentration is reaching a threshold associated with the user's weight and height). In some embodiments, the dispensing system 200 includes disposable mouthpieces for the breathalyzer so each user do not share breathalyzer mouth pieces. In some embodiments, users may choose to provide their own breathalyzer mouth pieces for sanitary and health reasons.

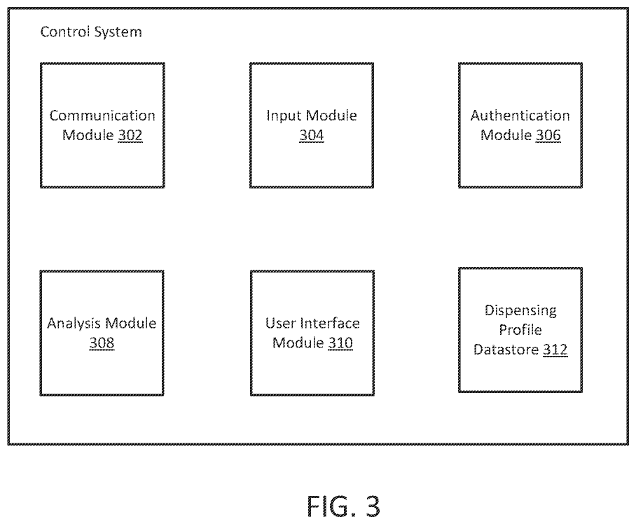

FIG. 3 is a block diagram of an example dispensing control system 300 according to some embodiments. The dispensing control system 300 includes a communication module 302, an input module 304, an authentication module 306, an analysis module 308, a user interface module 310, and a dispensing profile datastore 312.

The communication module 302 may send and receive requests or data between any of the modules of the dispensing control system 300.

In some embodiments, the input module 304 may receive control signals from a local control system of the dispensing system and/or from one of the user systems of the dispensing system 200. The local control system may include, for example, a graphics display unit such as a touchscreen monitor. In some embodiments, the graphical user interface additionally include physical buttons. The touchscreen monitors and/or physical buttons may be situated or placed directly on the dispensing system. The user may interact with the graphical user interface to control one or more aspects of the dispensing system. In various embodiments, the input module 304 may receive properties of one or more compressible liquid volumes such as the type of beverage/liquid (red wine, white wine, coffee, soft serve, etc.), a viscosity of the beverage/liquid, the minimum diameter of conduit required for the beverage/liquid, and/or any temperature constraints. In some embodiments, the input module 304 may receive this information when a compressible liquid volume is first introduced or first stored in the pressurized canister/cartridges.

In some embodiments, the input module 304 may receive data from an image capture device. In one example, the dispensing system includes image capture device capable of capturing digital images or video, which may be live-streamed or remotely viewable on a graphics display unit coupled to the dispensing system, a user interface or a mobile computing device such as a smart phone. The input module 304 may send the digital images of a user captured by the image capture device to the authentication module 306 to authenticate the user's identity or to the analysis module 308 to estimate the user's physical characteristics such as weight and height to determine if a beverage requested by the user should be dispensed or if a recipe associated with the requested beverage should be modified based on the user's height, weight, and/or previously ordered drinks.

In some embodiments, the input module 304 may receive a digital image of the user's government-issued identification, such as a state-issued driver's license. The authentication module 306 may use the digital image of the user's government-issued identification to determine if the user is of legal drinking age. In various embodiments, authentication module 306 may include ways to authenticate the government-issued identification. For example, the authentication module may authenticate facial features of the digital image of the user's government-issued identification by comparing the facial features to that of a digital image of the user (e.g., via a camera) to determine if the person who presented the government-issued identification (e.g., a person requesting a drink) to the dispensing control system 204 is the same as the person depicted in the government-issued identification. It will be appreciated that, in these examples, any identification may be used and may not be limited to a government-issued identification (e.g., the identification may be issued by a bar, restaurant, or the like for servers and/or consumers for self-service).

In some embodiments, the input module 304 may receive data from a breathalyzer. The breathalyzer is used to estimate blood alcohol content (BAC) from a breath sample. The output of a breathalyzer may be the estimated BAC of the user stated as a percentage or decimal value. The input module 304 may receive the output of the breathalyzer and send the estimated BAC to the analysis module 308 for analysis.

The authentication module 306 may authenticate the user's identity. In some embodiments, the authentication module 306 may utilize biometric data from the user to authenticate their identity. For example, fingerprints, facial, or voice recognition may be utilized to authenticate a user's identity (e.g., a consumer or server's identity). In some embodiments, a user may remotely control the dispensing system using a software application installed on a mobile computing device. The mobile computing device may include authentication of the user's identity using one or more of the mobile computing device's security features such as facial recognition, fingerprint sensors, retinal scan, and the like. The authentication module 306 may take advantage of the mobile computing device's security features to authenticate the user's identity.

In one example, the authentication module 306 may utilize artificial intelligence to analyze the user's digital image to visually determine a level of intoxication. Visual cues may be used to identify or gauge a level of intoxication in a person, visual cues such as flushed or red face, droopy eyelids, red and watery eyes, and the like. In various embodiments, the authentication module 306 may utilize artificial intelligence to analyze a digital video of the user captured by the image capture device during the course of the user's interaction with the dispensing system 200 to order a beverage. The artificial intelligence may identify visual cues, such as unsteadiness and slurred speech, that may be used to identify or gauge a level of intoxication in a person.

In various embodiments, the authentication module 306 may determine if a user of the dispensing system has authority to control or manage a “self-service” stationary or mobile dispenser pour units. In one example, individual customers can be pre-authenticated and pre-authorized to operate the self-service dispenser pour units (for example, biometrically or via being provided a “token” such as a magnetic, NFC, or RFID device or an electronic token storable on their mobile device), enabling such pre-authorized customers to freely use self-service dispenser pour units, and, for example, charge their pours to their room in a hotel or to a previously provided credit card, or to a pre-authorized “allowance” (for example during an event). Such authentication can also serve to verify the customer's age. In various embodiments, certain thresholds may be required for operation. For example, before the initiation of pours of wines over $30 a glass, approval or authentication from a manager may be required. In some embodiments, the authentication module 306 may track the identification of each user initiating a pour along with all related information (size of beverage poured, beverage poured, etc.). The authentication module 306 may send data tracking the user's previously ordered drinks to determine if a user's requested drink should be modified, such as decreasing the alcohol content of the requested drink or a size of the requested drink because the user's previous drink orders and a change in the particular user's blood alcohol concentration.

The analysis module 308 may receive data from the input module 304 and the authentication module 306. The analysis module 308 may utilize the output of the breathalyzer received from the input module 304 to determine if the user's requested drink should be modified. For example, if the user's BAC is increasing faster than a predetermined threshold (e.g., a predetermined threshold of change), the analysis module 308 may recommend that the alcohol content of the user's requested drink should be decreased. The analysis module 308 may provide the recommendation to the user interface module 310. The user interface module 310 may, in turn, provide the recommendation to a graphic display unit of a dispensing unit or a mobile software application on the user's mobile computing device. In one example, the analysis module 308 provides suggestions of other beverages to provide to the user.

The analysis module 308 may receive pre-defined recipes for beverages and food items using one or more of the compressible liquid volumes of the pressurized canister/cartridges. The pre-defined recipe may specify an amount of each of the ingredients of the beverage or food item and an order with which to add or mix the ingredients. The analysis module 308 may utilize the pre-defined recipe to determine parameters (e.g., to create profiles) such as a period of time and an amount of pressure to apply to the pressurized canister/cartridge by a controllable pressure system to allow liquid to be selectively dispensed through a normally locked dispensing conduit connected to the pressurized canister/cartridge. Furthermore, the analysis module 308 may utilize the pre-defined recipe to determine parameters such as a length of time to selectively open one or more controllable solenoids or valves to allow one or more liquids to flow from the compressible liquid volume in the pressurized canister/cartridge, through its respective transport conduit, and to a dispensing interface. In some embodiments, one or more liquids may flow to an internal or external mixing mechanism before arriving at the dispensing interface. In some embodiments, the analysis module 308 may determine parameters such as a length of time to activate the internal or external mixing mechanism and a speed function of the internal or external mixing mechanism. The analysis module 308 may determine these parameters based on at least a viscosity of the liquid contained within the compressible liquid volume and the diameter of the conduit coupled to the compressible liquid volume. Once the analysis module 308 determines the parameters, the analysis module 308 may send these parameters to the dispensing profile datastore 312.

In some embodiments, the analysis module 308 may estimate when a particular compressible liquid volume requires replacement (e.g., based on an amount of a particular product was originally in the compressible container, the amount dispensed from that particular compressible container, number of drinks with liquid from that particular container served, and/or the like). The analysis module 308 may send this information to the consumable tracking system for tracking and analysis. In some embodiments, the analysis module 308 may determine or estimate the number of beverages dispensed by any number of compressible liquid volumes.

In various embodiments, the analysis module 308 may track individual beverage inventories and either provide re-order alerts or automatically place re-orders when particular beverage inventories drop below specified levels). In one embodiment, the analysis module 308 may initiate an automatic cleaning and sanitization of the transport conduits of the dispensing system 200 by selectively opening solenoids or valves coupled to compressible liquid volumes filled with cleaning solution.

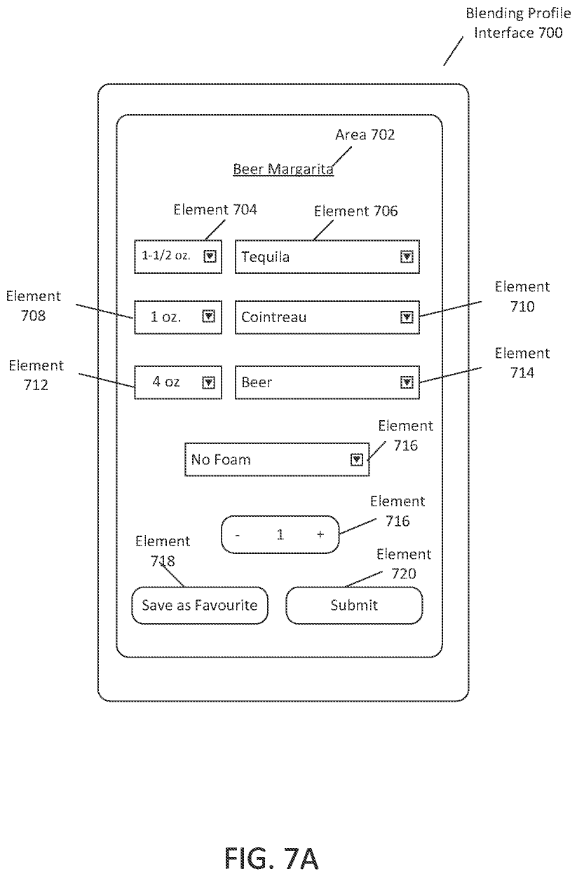

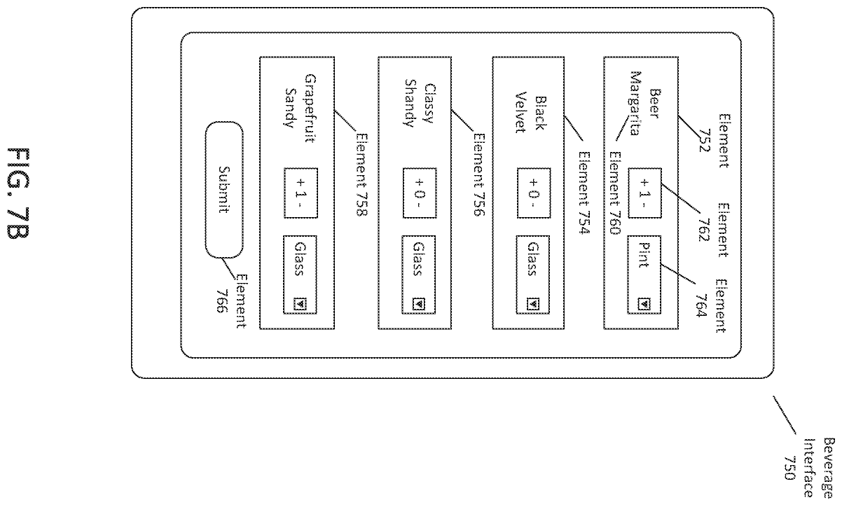

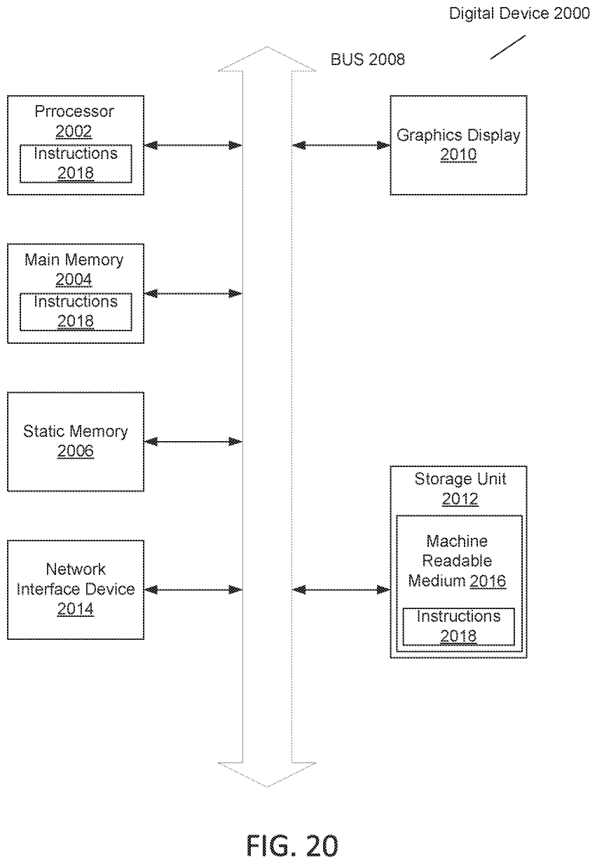

The user interface module 310 may provide one or more user interfaces to a graphical display of a user system. An example of the user system can be seen in FIG. 20. Examples of user interfaces can be found in FIGS. 7A and 7B.

The dispensing profile datastore 312 may be any structure and/or structures suitable for storing data entries or records (e.g., an active database, a relational database, a self-referential database, a table, a matrix, an array, a flat file, a documented-oriented storage system, a non-relational No-SQL system, an FTS-management system such as Lucene/Solar, and the like). The dispensing profile datastore 312 may create dispensing profile entries for each recipe received by the dispensing system 200. In some embodiments, recipes may be customized or pre-defined by one or more users of the dispensing system 200. Each dispensing profile entry may include the names of all the ingredients required in the recipe. The dispensing profile may further include control parameters associated with the recipe's provision. Control parameters may include a period of time and an amount of pressure to apply to the pressurized canister/cartridge, a length of time to selectively open one or more controllable solenoids or valves to allow one or more liquids to flow from the compressible liquid volume in the pressurized canister/cartridge. In some embodiments, control parameters may include a temperature to heat or cool the pressurized canister/cartridge or a mixing mechanism.

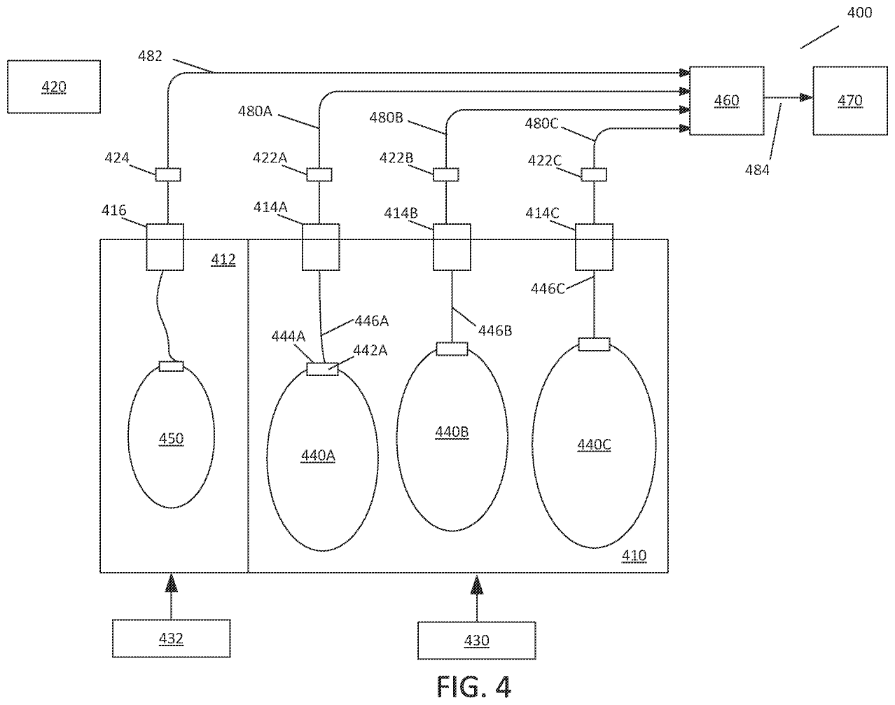

FIG. 4 is an illustrative diagram of a dispensing system 400 capable of re-alcoholizing, storing, preserving, managing, and selectively dispensing beverages or food-like substances in some embodiments. The example of FIG. 4 may be similar to that of FIG. 1A. The dispensing system 400 includes pressurized canister/pressurized containers 410 and 412, a control system 420, controllable pressure systems 430 and 432, a mixing mechanism 460, and a dispensing unit 470.

The pressurized container 410 may include compressible liquid containers 440A, 440B, and 440C (individually, collectively, compressible container 440). In some embodiments, the compressible liquid container 440A contains liquids or beverages such as beer concentrate. In one example, the compressible liquid container 440B contains vodka or any other alcohol that may be mixed with beer. In this example, vodka may be mixed with beer concentrate to rehydrate or re-alcoholize the beer concentrate to create beer. Beer is at least 90% water, with the remaining 10% including ethanol and other elements. Depending on the type or brand of the beer, the ratio between water and the remaining components may vary. In one example, beer concentrate is comprised of 20% of the water of beer.

In some embodiments, the compressible liquid container 440C contains malt syrup which is created by infusing malt with hot water. The malt or some other grain may provide sugar. In various embodiments, one or more of the compressible container 440 contains chocolate flavoring, sugar syrup, fruit syrups, or coffee syrup for various types of beverages or food items. In some embodiments, the compressible container 450 of the pressurized container 412 may contain water, detergent, or a cleaning solution to clean or the mixing mechanism 460.

As discussed herein, each of the compressible containers 440 may include a volume interface (e.g., a locking mechanism) for accessing or providing the liquid stored therein. A volume interface may be configured for a sealed/airtight connection to a releasable coupling that, in turn, couples their corresponding compressible container to a conduit. For example, the compressible liquid containers 440A includes a volume interface 442A (e.g., a nozzle or equivalent) for accessing the liquid stored therein, configured for a sealed/airtight connection to a releasable coupling 444A, that in turn couples to the compressible liquid container 440A to a liquid transport conduit 446A. In one example, the volume interface 442A may include a releasable sealed connector element operable to form a releasable connection with the liquid transport conduit 446A so that the liquid transport conduit 446A can be readily disconnected if replacement or either component is necessary. The sealed connector element of the releasable coupling 444A may include a releasable adaptive pressurized filling that increases in strength and reliability in response to an increase in the pressure that is exerted in the dispensing system 400 (e.g., such as a pressurized “O-Ring” fitting).

The liquid transport conduit 446A may couple to the compressible container 440A to a pressurized container interface 414A. The pressurized container interface 414A may be positioned, sized, and configured to align to “plug in” or otherwise securely couple to the corresponding pressurization and liquid delivery conduits when placed into a correspondingly configured “docking station” or equivalent. In some embodiments, the pressurized container interface 414A may include 1-way check valves (or combination control and 1-way check valves). While the liquid transport conduits 446A, 446B, 446C, 480A, 480B, 480C, and 482 may be of any sterile materials, they may be composed of flexible material that enables the dispensing system 400 to take advantage of the “hammer effect” to increase the speed of the liquid being dispensed therethrough.

In some embodiments, the control system 420 controls various aspects of the dispensing system 100. In some embodiments, the control system 420 controls features of the dispensing system 400 (e.g., using the dispensing profile(s)), such as the amount of pressure applied to the pressurized container/cartridge, temperature, dispensing profiles, user profiles, solenoid valves, and dispense pour units.

In various embodiments, the controllable pressure systems 430 and 432 are coupled to the pressurized containers 410 and 412, respectively. The controllable pressure systems 430 and 432 are selected and configured to provide direct pressurization to the compressible container stored therein to generate and maintain the pressurized environment within the necessary/desired parameters.

The liquid transport conduits 480A, 480B, 480C, and 482 may be coupled to the mixing mechanism 460. In some examples, one or more of the mixing mechanisms 460 may include venturi systems, mixing chambers, nozzles of different sizes, and/or the like. In some embodiments, the mixing mechanism 460 includes a mixing tube such as a static mixing tube. A liquid transport conduit 484 may be coupled between the mixing mechanism 460 and the dispensing unit 470 to transport liquids from the mixing mechanism 460 to a dispensing unit 470. The dispensing unit 470 may include some or all of the components of the dispensing pour units of FIG. 14A through 14C.

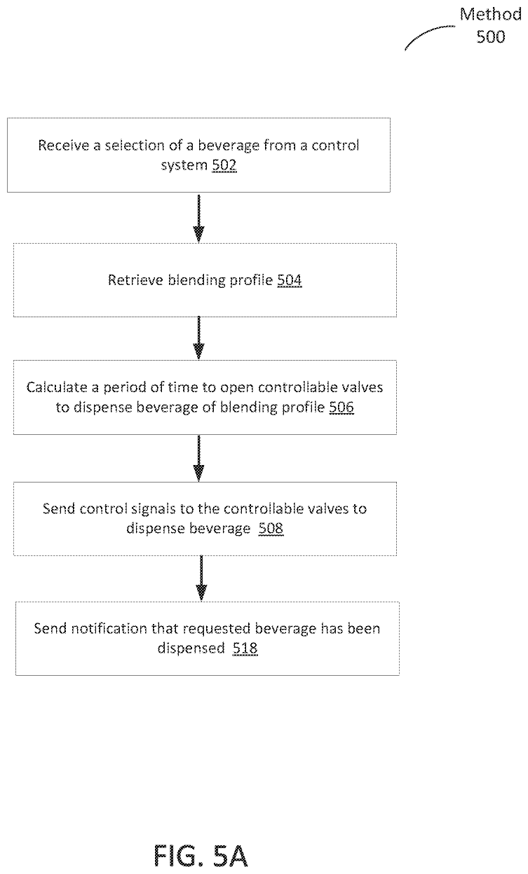

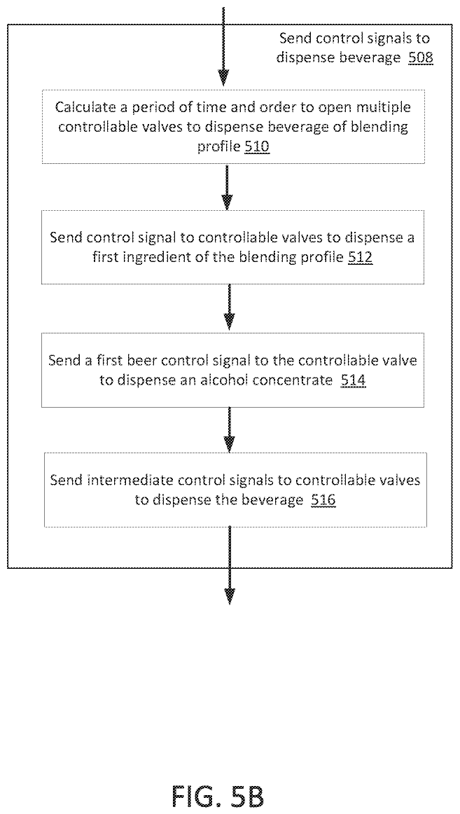

FIG. 5A is a flow chart of a method 500 of dispensing a beverage according to some embodiments. In step 502, a control system, such as the dispensing control system 204 of FIG. 2A may receive a control signal from the user of the dispensing system 200. The user may interact with the blending profile interface 700 of FIG. 7A or the beverage interface 750 of FIG. 7B to submit a default blending profile or a customized blending profile. The dispensing control system 204 may receive a request from the blending profile interface to blend a particular beverage or food-like substance. For example, the dispensing control system 204 receives a control signal from the user for blending profile, corresponding to a beer margarita consisting of 4 oz. of beer, 1 ½ oz of tequila, and 1 oz. of Cointreau. In some embodiments, the user may interact with the blending profile interface 700 to increase or decrease the amount of alcohol in their beverage.

In some embodiments, the input module 304 of the dispensing control system 204 receives digital images of the user captured by the image capture device to the authentication module 306 to authenticate the user's identity or to the analysis module 308 to estimate the user's physical characteristics such as weight and height to determine if a beverage requested by the user should be dispensed (e.g., the user is likely old enough) or if a recipe associated with the requested beverage should be modified based on the user's height, weight, and/or previously ordered drinks.

In step 504, the control system 120 may query a database of blending profiles or customized blending profiles for a recipe or blending profile matching the request. The database may be a data structure for storing information that is a part of the dispensing system and may be local to the commercial establishment. In some embodiments, the database may be stored in a cloud-based infrastructure accessible by a particular commercial establishment (or accessible to some or all commercial establishments that utilize the same dispensing system).

Once the requested blending profile has been found in the database of blending profiles or customized blending profiles, the dispensing control system 204 may identify one or more ingredients required to produce the beverage or food-like substance. In some embodiments, the analysis module 308 may modify the ratio of ingredients of the requested beverage based on the user's height, weight, and/or previously ordered drinks.

The request may also include an amount of each ingredient required to produce the beverage or food-like substance. In some embodiments, the request may include an order with which to dispense the different ingredients if necessary. For example, the control system 120 may identify one compressible liquid container containing beer concentrate and another compressible liquid container containing Cointreau, the controllable valves coupled to the one compressible container and another compressible container. If one or more ingredients are missing, or if there is an insufficient amount of one or more ingredients, the control system 120 may notify the user that the beverage cannot be made due to a missing ingredient. Alternately, the control system 120 may determine if there is a low or insufficient product in any number of sources (e.g., compressible containers, hoppers, flavorings, CO₂, or the like) and may control the graphical user interface to indicate that certain beverages are not currently available.

In step 506, the dispensing control system 204 utilizes the blending profile to determine parameters (e.g., to be included in a beverage profile) such as a period of time that each of the controllable valves (coupled to the compressible liquid volumes required to produce the beverage or food-like substance) should be opened for to dispense the beverage or food-like substance. The dispensing control system 204 may determine a period of time based on, for example, a viscosity of the liquid contained within the compressible container, the diameter of the conduit coupled to the compressible container and dispensing interface, temperature of the dispensing system, and/or pressure of the controllable valve. One or more of these properties may affect the period of time with which the controllable valve needs to be opened or enabled to allow a sufficient measure of liquid to flow through the liquid transport conduit to make the pre-defined recipe. In some embodiments, the dispensing control system 204 determines an amount of pressure to apply to the pressurized canister/cartridge by the controllable pressure system to allow liquid to be selectively dispensed through a dispensing conduit connected to the pressurized canister/cartridge (e.g., in conjunction with opening a solenoid to allow the flow of liquid). In various embodiments, properties of the compressible container may be inputted to the dispensing control system 204 using other methods such as container IDs which may comprise labels (bar codes, QR codes, or RFID tags).

The dispensing control system 204 may determine a period of time to open or enable one controllable valve coupled to one compressible container which contains vodka and another period of time to open or enable another controllable valve coupled to another compressible container that contains vermouth. The dispensing control system 204 may send a control signal to the dispensing system to dispense the beverage or food-like substance. The control signals may include the above-identified one period of time and another period of time.

In step 508, the dispensing control system 204 may send the control signal(s) to the dispensing system to dispense the beverage or food-like substance corresponding to the requested blending profile. In some embodiments, the control signal includes electronic signals to control an electromechanical control component of the controllable valve. In one example, the control signal(s) includes electronic signals to control the mixing mechanisms of the dispensing system. Further details regarding step 508 may be seen in FIG. 5B. In some embodiments, the control signal includes an electronic signal to automatically dispense the beverage once the beverage is ready to be dispensed.

In step 518, the user interface module 310 of the dispensing control system 204 may send a notification (e.g., local or remote) to the user who requested the beverage or food-like substance corresponding to the requested blending profile has been dispensed.

FIG. 5B is a flow chart of the step 508 from the method 500 of dispensing a beverage of FIG. 5A. In step 510, the dispensing system may receive from the dispensing control system 204 the control signal(s) to dispense the beverage or food-like substance corresponding to the requested blending profile. For example, in step 506, the dispensing control system 204 determines one period of time to open or enable a controllable valve (e.g., a solenoid valve) coupled to a compressible container containing beer concentrate. The dispensing control system 204 may send an electronic signal to the electromechanical control component of the controllable valve coupled to the compressible container, which contains beer concentrate, to open the controllable valve for the duration of the previously determined one period of time (thereby enabling pressure from the pressure system to dispel product from a compressible container coupled to the controllable valve).

In step 506, the dispensing control system 204 determines another period of time to open or enable one controllable valve coupled to one compressible container, which, in this example, contains tequila. The dispensing control system 204 may determine an amount of beer required by the requested blending profile. Based on the required amount of beer, the dispensing control system 204 may determine a period of time to open or enable a controllable valve coupled to a compressible container containing beer concentrate or alcohol concentrate. In step 512, the dispensing control system 204 sends an electronic signal to the electromechanical control component of the controllable valve coupled to the compressible container, to open the controllable valve for the duration of the determined period of time. In this example, beer concentrate or alcohol concentrate stored in the compressible liquid container 214A of FIG. 2A may be provided through the controllable valve to be mixed and/or dispensed.

Based on the required amount of product to be dispensed, the dispensing control system 204 may determine a period of time to open or enable a controllable valve coupled to a compressible container containing any product (e.g., vodka or malt syrup). In step 514, the dispensing control system 204 sends an electronic signal to the electromechanical control component of the controllable valve coupled to the compressible container, to open the controllable valve for the duration of the determined period of time. In some embodiments, the vodka or malt syrup is stored in an airtight container, such as the air-tight container 150 of FIG. 1A. The control system 120 may send an electronic signal to the electromechanical control component of the controllable valve coupled to the air-tight container 150 to enable the flow of vodka or malt syrup to be mixed with beer concentrate in the mixing chamber. The liquid transport conduit may be coupled between the controllable valve and a mixing mechanism.

Based on the required amount of product, the dispensing control system 204 may determine a period of time to open or enable a controllable valve coupled to a compressible container containing distilled and/or carbonated water. In step 516, the dispensing control system 204 sends an electronic signal to the electromechanical control component of the controllable valve coupled to the compressible container, to open the controllable valve for the duration of the determined period of time, to enable the flow of distilled and/or carbonated water. In some embodiments, the distilled water or tap water may be delivered to the mixing mechanism via liquid transport conduits. In one example, distilled water or tap water may be carbonated using the carbonation system 208 of FIG. 2A. The carbonation pump 228 of the carbonation system 208 may be operable to selectively add carbonation to a beverage being dispensed. The dispensing control system 204 may determine an amount of carbon dioxide gas to send to the carbonation pump 228 based on a number of factors, including, for example, a quantity and temperature of the carbonated beverage to be dispensed by the system. In some embodiments, water from the water line 230 may be carbonated in the carbonation pump 228 of FIG. 2A.

A liquid transport conduit may couple an output of the carbonation pump 228 to the mixing mechanism via a solenoid. The mixing mechanism may include venturi systems, a mix propeller, an in-line mixing chamber, a vortex generator apparatus, an ultrasonic homogenizer, nozzles of different sizes, and/or the like. In one example, the mixing mechanism includes a mixing tube, such as a static mixing tube.

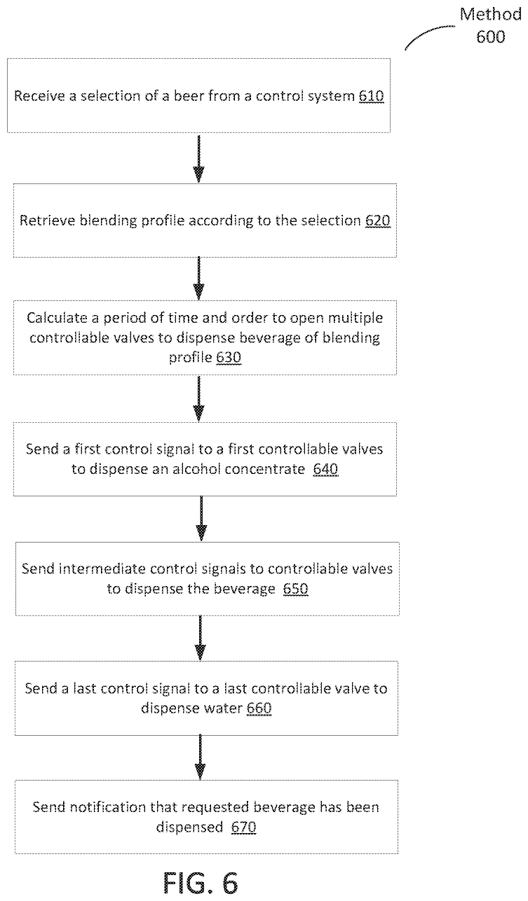

FIG. 6 is a flow chart of a method 600 of dispensing a beverage according to some embodiments. In step 610, a control system, such as the dispensing control system 204 of FIG. 2A may receive a control signal from the user of the dispensing system 200. The user may interact with the blending profile interface 700 of FIG. 7A or the beverage interface 750 of FIG. 7B to submit a blending profile (e.g., a default blending profile) or a customized blending profile. The dispensing control system 204 may receive a request from the blending profile interface to blend a particular beverage or food-like substance.

In step 620, similar to step 504 of FIG. 7A, the dispensing control system 204 may query a database of blending profiles or customized blending profiles for a recipe or blending profile matching the request. The database may be a data structure for storing information that is a part of the dispensing system and may be local to the commercial establishment. In some embodiments, the database may be stored in a cloud-based infrastructure accessible by a particular commercial establishment. In some embodiments, the database may be stored in a cloud-based infrastructure accessible by some (e.g., a subset) or all commercial establishments that utilize the same dispensing system.

In step 630, the dispensing control system 204 utilizes the blending profile to determine parameters (e.g., to be included in a beverage profile). In one example, the parameters may include, for example, a period of time that each of the controllable valves coupled to the compressible liquid volumes required to dispense beverages. In this example, the beverage profile stored in the dispensing profile datastore 312 corresponds to a predetermined amount of each ingredient used to make the beverage according to the beverage profile. In some embodiments, the analysis module 308 may determine that the amount of one or more ingredients may need to deviate from the beverage profile. In one example, a determination for an amount of alcohol a drink contains may be made in real-time (e.g., based on one or more of the user's physical characteristics, results from a breathalyzer test obtained by the user, and/or a history of the user's previously ordered drinks).

As discussed herein, the period of time to open or close a valve to enable the flow of liquid for a beverage may be based on the viscosity of the liquid contained within the compressible container, the diameter of the conduit coupled to the compressible container, the temperature of the dispensing system, and/or pressure on the controllable valve. One or more of these properties may affect the period of time with which the controllable valve needs to be opened or enabled to allow a sufficient measure of liquid to flow through the liquid transport conduit to make the pre-defined recipe. In some embodiments, the dispensing control system 204 determines an amount of pressure to apply to the pressurized canister/cartridge by a controllable pressure system to allow the beverage or food-like substance (or other material) to be selectively dispensed through a normally locked dispensing conduit connected to the pressurized canister/cartridge. In various embodiments, properties of the compressible container and/or contents of the compressible container may be inputted to the dispensing control system 204 using other methods such as container IDs (e.g., which may comprise labels bar codes, QR codes, or RFID tags).

The dispensing control system 204 may determine the amount of beer (or beverage) required by the requested blending profile. In this example, based on the required amount of beer, the dispensing control system 204 may determine a period of time to open or enable a controllable valve coupled to a compressible container that contains beer concentrate or alcohol concentrate. In step 640, the dispensing control system 204 sends an electronic signal(s) to the electromechanical control component of the controllable valve coupled to the compressible container to open the controllable valve for the duration of the determined period of time. In some embodiments, the beer concentrate or alcohol concentrate is stored in compressible liquid containers 214A. The liquid transport conduit may be coupled between the controllable valve and an optional mixing mechanism. The mixing mechanism may include, for example, venturi systems, a mix propeller, an in-line mixing chamber, a vortex generator apparatus, an ultrasonic homogenizer, nozzles of different sizes, and/or the like. In one example, the mixing mechanism includes a mixing tube, such as a static mixing tube.

In step 650, the dispensing control system 204 sends an electronic signal(s) to the electromechanical control component of the controllable valve coupled to the compressible container to open the controllable valve for the duration of the determined period of time. In some embodiments, the beer vodka or malt syrup is stored in compressible liquid containers 214A, the dispensing control system 204 may send an electronic signal to the electromechanical control component of the controllable valve coupled to the compressible liquid containers 214A. The liquid transport conduit may be coupled between the controllable valve and a mixing mechanism.

In step 660, the dispensing control system 204 sends an electronic signal to the electromechanical control component of the controllable valve coupled to the compressible container to open the controllable valve for the duration of the determined period of time. In some embodiments, distilled or tap water may be delivered to the mixing mechanism via liquid transport conduits or from an external source (e.g., outside the compressible containers and not in the pressurized environment)). In some embodiments, distilled or tap water may be carbonated using the carbonation pump 228 of the carbonation system 208.

The carbonation pump 228 of the carbonation system 208 may be operable to selectively add carbonation to a beverage being dispensed. The dispensing control system 204 may determine an amount of carbon dioxide gas (or any material that can carbonate a liquid) to send to the air-tight container 150 based on a number of factors, including, for example, a quantity and temperature of the carbonated beverage to be dispensed by the system, a head to be dispensed, and/or the like. In some embodiments, water may be carbonated in the carbonation pump 228 using the CO₂ tank 226 and the water line 230. A liquid transport conduit may be coupled to an output of the air-tight container and the mixing mechanism. The mixing mechanism may include venturi systems, mixing chambers, nozzles of different sizes, and/or the like. In one example, the mixing mechanism includes a mixing tube, such as a static mixing tube.

In step 670, the dispensing control system 204 may send a notification (e.g., local or remote) to the user who requested the beverage or food-like substance corresponding to the requested blending profile has been dispensed.

FIG. 7A is an example user interface for a dispensing system that can customize a blending profile according to some embodiments. In some embodiments, the example user interface may allow a user to customize a default blending profile. The example user interface of FIG. 7A includes a blending profile interface 700. The blending profile interface 700 may be provided to a graphics display of a user system, such as a mobile computing device. The user may interact with the blending profile interface 700 to execute program/control instructions. For example, an employee of a commercial establishment or a patron of the commercial establishment may interact with the blending profile interface 700 to remotely dispense a beverage from the dispensing system of the entertainment venue. The blending profile may, in some embodiments, allow for rehydration and re-alcoholization when serving rehydrated beer.

In some embodiments, the blending profile interface 700 includes multiple elements, such as element 702, which depicts the name of a beverage associated with the blending profile or recipe. The name of the blending profile may be customized. For example, a user of the dispensing system may rename the name of a beverage to be displayed in the interface. The user that has rights to change the name of the beverage within the dispensing system may be an employee of a commercial establishment. In various embodiments, the user of the dispensing system may be a mobile computing device provided by the commercial establishment to allow patrons to order beverages and foods from a tablet device or a mobile software application program made available by the commercial establishment to patrons on the patrons' mobile computing device.

The user of the dispensing system may customize a beverage by varying the amount of each ingredient used in the blending profile. In one example, the blending profile interface 700 depicts a blending profile or recipe for a “beer margarita.” The user of the dispensing system may interact with a drop-down list in element 704 and change the proportionality of tequila in the drink. In this example, a user may utilize a drop-down list to choose to increase or decrease the amount of tequila in the beverage. In another example, the user of the dispensing system may interact with a drop-down list in element 706 to change the type of tequila that the beverage uses. For example, the user may choose a blanco tequila, reposado tequila, añejo tequila, extra añejo tequila, cristalino tequila, or a “high-shelf” tequila. The types of tequila available in the drop-down list or menu depend on the types of tequila available in the dispensing system. A change of the blending profile from a default may change the price of the beverage. For example, the default “beer margarita” profile may include 1 ½ ounces (oz) of tequila.

The user of the dispensing system may interact with element 708 and change the proportionality of Cointreau or triple see in the drink. The user may choose to increase or decrease the amount of triple see in the beverage. An increase or decrease in the amount of soda in the beverage may change the price of the beverage. The user of the dispensing system may interact with a drop-down list in an element 710 to change the type of triple see that may be used in the beverage. In some embodiments, the types of triple see available in the drop-down list or menu depend on the types of triple see available to the dispensing system. A change of the blending profile from a default may change the price of the beverage.

Similar to elements 704 and 706, the user of the dispensing system may interact with drop-down lists in elements 712 and 714 to customize an amount and type of beer to add to the beverage. For example, the user may choose to add 4 oz. of beer to the beer margarita.

When the user interacts with element 716, the user may further customize the drink by determining an amount of beer head or beer foam to add to the drink. The amount of beer head or beer foam dispensed by the dispensing system may be determined based on an amount of carbonated water dispensed by the dispensing system (e.g., the user interface may direct the system to add, reduce, or eliminate carbonated water from the beverage).

The user of the dispensing system may interact with element 716 to change a quantity of beverages corresponding to the blending profile to submit to the dispensing system. The user may interact with element 718 to save a customized blending profile so that it can be easily re-submitted without going through the customization steps listed above.

The user may interact with element 720 to submit a beverage corresponding to the blending profile. In response to the user submitting the beverage corresponding to the blending profile to the dispensing system, the control system of the dispensing system may send a control signal to the dispensing system. The control system may identify one or more parameters of the dispensing system that require activation in order to dispense the beverage. For example, the control system may identify one or more compressible liquid volumes of the dispensing system, which contains the tequila, triple see, and beer for the beer margarita, and determine a period of time that each of the controllable valves or solenoids coupled to the identified compressible liquid volumes should be opened for to enable an amount of tequila, triple see, and beer, as identified in the blending profile, to the dispensing unit. In this example, the control system may identify a carbonated liquid line (e.g., identify a needed line, conduit, and/or compressible container identifier) that may be used as a part of the beverage and determine a period of time a controllable valve or pump coupled to the carbonated liquid line should be opened or operated to enable an amount of carbonated water, as identified in the blending profile, to be a dispensing unit. The period of time each of the controllable valves needs to be opened or enabled to allow the liquid in the liquid transport conduit coupled to each of the controllable valves depends on many factors, including the viscosity of the liquid, the diameter of the liquid transport conduit, the temperature of the liquid, and pressure of the controllable valve.

FIG. 7B is an example user interface for a dispensing system to dispense beverages based on blending profiles according to some embodiments. In some embodiments, a beverage interface 750 includes multiple elements, such as elements 752, 754, 756, and 758, which depict different types of beverages that may be chosen. For example, the user may utilize the beverage interface 750 to dispense beverages such as beer margaritas, black velvet, classy shandy, grapefruit sandy, or mimosa. Each of the elements may include multiple fields, such as element 760, which indicates the name of the beverage (which may be customized). The user may interact with elements 762 and 764 to provide an indication of a quantity and a type of container. For example, a user may interact with element 762 to choose the number of beverages. The user may interact with element 764 to select the type of container, such as a pint glass or a carafe. Once the user has made their selection, the user may interact with element 766 of the beverage interface 750 to submit the order. In some embodiments, the beverage interface 750 may be remotely operable to control multiple dispensing systems or pressurized containers of the entertainment venue. In one example, an interface similar to beverage interface 750 may be utilized to remotely control a dispensing system to dispense food-like substances.

Referring now to FIGS. 14A-14C, each of the various dispensing pour units that may be utilized in connection with the dispensing system 200 of FIG. 2A (such as any of the dispensing units 212) may comprise any apparatus, device, or system suitable for dispensing beverages (e.g., wine) via pours into an appropriate container (e.g., a wine glass) when one of the dispensing functions of the dispensing system 200 is activated. For example, a dispensing pour unit may be a simple spout, a gun-type hand-operable manual dispenser, or it may comprise a vertically elongated housing comprising an opening sized and configured to receive a wine glass therein, such that a glass (e.g., wineglass) can be positioned beneath a pour element to ensure that the dispensed liquid enters, and remains entirely within, the wine glass during the dispensing process (such as example dispensing pour unit 1400 of FIG. 14A).

Referring now to FIG. 14A, an example of a dispenser pour component (such as any of the dispensing unit 170 of FIG. 1A or the dispensing unit 212 of FIG. 2A) is shown, in multiple views, as a dispensing pour unit 1400. The dispensing pour unit 1400 may be located, disposed, and/or otherwise positioned, in whole or in part, in one of several dispensing pour unit (“DPU”) regions A to C (as shown, by way of example only, in FIG. 14A), and which may include, but which are not limited to, one or more of the following:
A. Optional flow sensor (e.g., a flow meter) or equivalent means of sensing the quantity of liquid that has been dispensed in each metered pour. In some embodiments, the flow sensor may include an image capture device.
B. Digital images or video captured by the image capture device may be sent or stored for viewing by one or more users of the dispensing system 100 for quality control or security purposes. For example, a shift manager or owner of a restaurant may monitor a beverage dispensed or being dispensed by the dispensing interface of the dispensing system 100 to determine if the quality of the beverage is up to the standard of the restaurant. Furthermore, the shift manager or owner may determine if the quantity of wine dispensed by the dispensing system 100 when a member of the wait staff interacts with the graphical user interface of the local dispensing control system and requests a glass of wine corresponds to the quantity set by the owner of the restaurant. If there is a discrepancy between the two, the dispensing system 100 may require calibration.
C. Pour/Dispense Activation (e.g., the manner in which the dispensing of the wine is initiated) may include one or more of the following:
   1. Manual Control: manual control may be activated by the user after a glass is positioned within the dispensing pour unit 1400 to cause the pressurized container 110 (that is coupled to the dispensing pour unit) to dispense a predefined quantity of product into the glass, which may include one or more of the following:
      i. push button, switch, or equivalent manually operated control element.
      ii. voice-based interface, which may provide additional features such as the ability to select a specific product or mixture to be poured in dispensing pour unit embodiments in which plural dispensing conduits are connected to a single dispensing pour unit.
      iii. remote control, having one, or both of the above types of controls activated implemented as an electromechanical device, or as a software application (for example, as an “App” in a mobile communication device).
   2. Automatic Control: automatic control may include automatic actuation when the dispensing pour unit detects that a correct glass or container is properly placed and aligned in the dispenser bay (for example, before a glass of Pinot Noir is poured, the dispensing pour unit may need to detect that the proper wine glass is situated in the dispenser bay), enabling immediate dispensing of a predefined “pour amount” of the wine into the glass. The manner in which glass placement and positioning occur may be selected as a matter of design choice and may comprise:
      i. Mechanical sensor-pressure sensor, sensing switch (e.g., roller ball switch, motion trip switch, or the like), or
      ii. Non-mechanical sensor-IR, ultrasonic, light-based, motion sensor, radio-frequency identification (RFID), near-field communication (NFC) or the like.
D. Available Pour Options identification-enabling identification for each dispensing pour unit, the corresponding “available to pour” product and, when applicable, available options (e.g., blended pours, carbonation, or the like), pour size control (e.g., for optionally dispensing different volume pours, such as smaller volume “tasting” pours), and may comprise, at each dispensing pour unit, an electronic display (optionally supplied with a graphical user interface), physical labels (or replaceable printed info card(s)), labeled buttons or other physical controls, or if the dispensing pour unit is operable to communicate therewith, via an App installed on a mobile device, or the like.
E. Glass Positioning/Alignment—may comprise structural and/or mechanical guides in the bottom portion of the dispenser bay to physically assist in guiding the glass or appropriate container into a proper position within the dispenser bay to receive product dispensed and/or may include visual cues to assist in positioning the glass or appropriate container, such as illustrative and/or color indicators. Optionally, sensor and/or electronic feedback features may also be included. These feedback features may include an indicator light and/or an audio tone that indicates when the glass or appropriate container is properly positioned. Additionally, a splash protection element (such as a flexible and optionally retractable flange or cover) may be provided to limit or substantially eliminate the possibility of the dispensing process causing the dispensed beverage to splash out of the glass or appropriate container.
F. Replaceable dispensing pour unit nozzles that may be utilized to enhance the product being dispensed (such as an aeration nozzle).
G. An optional light source operable to illuminate the glass or appropriate container into which the product is being dispensed during the dispensing process, such that the cessation of the illumination serves as an indicator that the dispensation has been completed (the completion of the dispensing process may also/alternately be indicated by other means, such as by an audio signal).
H. Authentication of the user identity biometrically (such as by a fingerprint sensor integrated into the pour control, by facial or voice recognition, and/or by other ID verification means—e.g., an RFID card, or the like.), where the user may be an authorized establishment employee, or a customer pre-enrolled with an account in the biometric system that is permitted to self-dispense from a biometric verification enabled dispensing pour unit.
I. A multi-pour nozzle, such as a multi-pour nozzle 1470, is shown in FIG. 14C, including a single nozzle “head” 1472 comprising a bundle of multiple nozzle elements 1474 (e.g., a bundle of nozzle elements) disposed therein, to enable the dispensing pour unit to dispense different beverages from multiple corresponding beverage sources. In one example, each product source comprising a dispenser conduit, connected to a corresponding nozzle element in the bundle and to a corresponding PSP system source, which may include one of:
   1. A multi-beverage single PSP system source(s) (e.g., different individual wine bags stored in the same PSP system pressurized canister), such as pressurized containers 1444 and 1446 shown in a multi-source dispensing arrangement 1440 of FIG. 14B.
   2. Multiple plural PSP system beverage sources (e.g., different individual wine bags, each stored in a different pressurized container), such as a pressurized container 1442 (and similar additional pressurized container (not shown) of FIG. 14B.
   3. Any combination of a multi-beverage single PSP system source(s) and multiple plural PSP system beverage sources, such as the pressurized containers 1442, 1444, and 1446 of FIG. 14B.

A multi-pour nozzle 1470 may comprise any reasonable number of nozzle elements ranging from 2 to 9 or more.

J. Any dispensing pour unit that includes a multi-pour nozzle (such as the multi-pour nozzle 1470) may be equipped with “Blended Pour” functionality, enabling a wide range of wines to be blended during the dispensing process, each blended pour being configured in accordance with at least the following parameters (collectively comprising a corresponding “Blended Pour Profile”): (1) selection of number and types of wine to be blended, and (2) selection of pour volume of each wine to be blended,
1. The blended pour functionality may be implemented in dispensing pour units equipped with a multi-pour nozzle (see above). During blended pour operation, multiple selected nozzle elements are activated substantially simultaneously (e.g., to dispense each wine to be blended in accordance with a selected predetermined Blended Pour Profile) to enable beverage blends (such as wine varietal blends) to be instantaneously produced in the glass positioned in the dispenser bay of the dispensing pour unit.
2. Blended Pour Profiles may be changed periodically (e.g., nightly) by the operating establishment to reflect beverage menu items and/or specials. Blended Pour Profiles may also be custom configured by an authorized operator of a dispensing pour unit on a case-by-case basis, and/or by an end user (e.g., a customer), for example, through a BMS system interface supplied by the operating establishment, or via an App installed on the customer's mobile data processing device, which may also provide Blended Pour Profile suggestions based on framed Bordeaux or other appellations, on various vintages and specific wines.

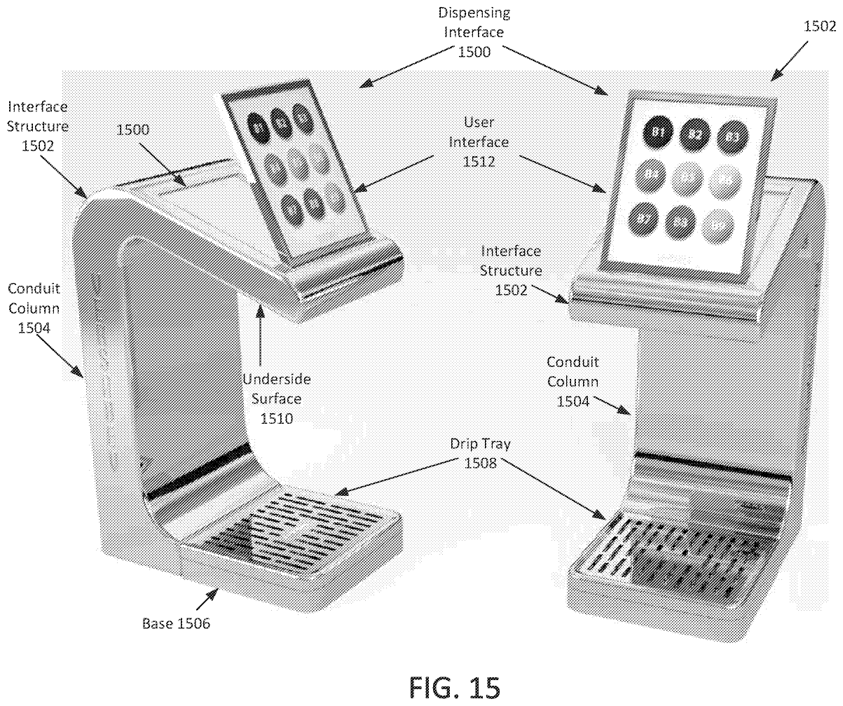

FIG. 15 is an illustrative diagram of two perspective views of a dispensing interface 1500 according to some embodiments. The dispensing interface 1500 includes an interface structure 1502. The interface structure 1502 may be composed of any material, including but not limited to non-reactive metal such as stainless steel or chrome.

In some embodiments, the interface structure 1502 includes a conduit column 1504. The conduit column 1504 may be hollow and provide a structure with which to support the one or more dispensing conduits that couple to a pressurized container containing one or more compressible liquid volumes. In some embodiments, the conduit column 1504 may include heating and/or cooling elements to maintain the beverage or food-like substance that traverses the dispensing conduit at a certain temperature. In one example, the conduit column 1504 includes insulation, which allows each of the one or more dispensing conduits to maintain the contents of the dispensing conduit at different temperatures.

The dispensing interface 1500 may include a base 1506. In some embodiments, the base 1506 may be weighted to provide stability to the dispensing interface 1500. The base 1506 may include a drip tray 1508. A container, such as a glass, cup, or some other container, capable of holding a beverage or food-like substance dispensed by the dispensing interface 1500 may be placed on the drip tray 1508. The dispensing conduits of the dispensing system may couple a pressurized container of the dispensing system to a dispenser (not shown) positioned on an underside surface 1510 of the dispensing interface 1500. In various embodiments, base 1506 includes an elevation component capable of selectively raising or lowering to decrease or increase the distance between the dispenser and the container positioned on the base 1506 to reduce spillage or splashing.

In some embodiments, the base 1506 is capable of positioning one glass or cup under the dispenser. In various embodiments, the base 1506 is circular, allowing one or more glasses or cups to rotate their respective position under the dispenser. Depending on the type of glass or cup in position under the dispensing conduit, the base 1506 may be raised or lowered. For example, an espresso cup placed on the base 1506 may cause an elevation component of the base 1506 to be raised to a position higher or closer to the dispenser than if a wine glass was placed on the base 1506.

In some embodiments, an elevation of the base 1506 is remotely controllable.

In one example, the base 1506 includes multiple base units, each of the multiple base units being capable of holding or positioning one glass or cup. The elevation of each of the multiple base units may be individually and/or remotely controllable by a software application.

The dispensing interface 1500 may include a user interface 1512. The user interface 1512 may include a graphics display unit such as a touchscreen monitor. In some embodiments, the graphical user interface may include physical buttons. The user may interact with the graphical user interface to execute program/control instructions, such as a request for the dispensing system to dispense a beverage. The user interface 1512 may include biometric identification units such as fingerprint sensors, image capture devices for facial recognition, or microphones for voice recognition in various embodiments.

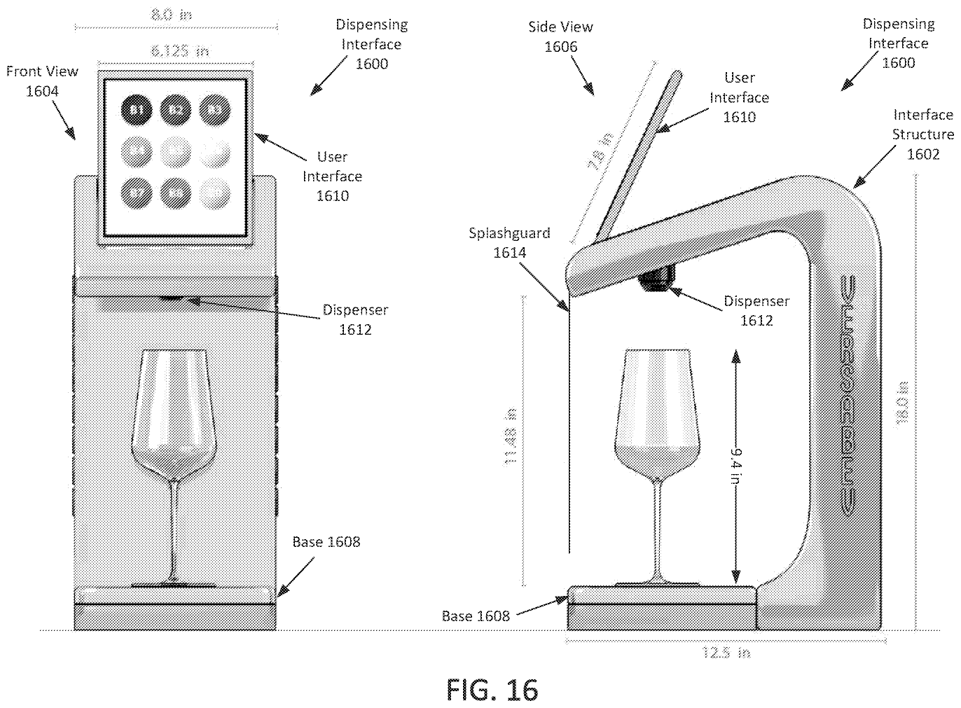

According to some embodiments, FIG. 16 depicts a front view 1604 and a side view 1606 of a dispensing interface 1600. The dispensing interface 1600 includes an interface structure 1602. The interface structure 1602 may be composed of a non-reactive metal such as stainless steel or chrome.

The dispensing interface 1600 may further include a base 1608. In some embodiments, the base 1608 is weighted to provide a supportive base to the dispensing interface 1600. The base 1608 may include a drip tray. In one example, the base 1608 includes an elevation component, such as a hydraulic lift, an air lift, a lift table, or a scissor lift to change a distance between a dispenser 1612 and a container placed on the base 1608 to catch or contain the beverage or food-like substance dispensed by the dispensing interface 1600. Spillage or splashing may be reduced by decreasing the distance between the dispenser 1612 and the container.

In various embodiments, the base 1608 includes mechanics which allow the base 1608 to rotate. For example, a rotating base may allow the dispensing interface 1600 to dispense soft serve ice cream into an ice cream cone or waffle cone with a twirl or twist.

In some embodiments, the dispenser 1612 includes a sensor to automatically or manually identify a type of container placed under the dispenser 1612. In one example, the sensor is an image capture device, capable of capturing digital images or video, which may be live-streamed or remotely viewable on a user interface 1610 or a mobile computing device such as a smart phone. In various embodiments, the sensor determines if the container is positioned correctly under the dispenser 1612.

The user interface 1610 may include a graphics display unit such as a touchscreen monitor. In some embodiments, the graphical user interface may include physical buttons. The user may interact with the graphical user interface to execute program/control instructions, such as a request for the dispensing system to dispense a beverage. In various embodiments, the user interface 1610 may include biometric identification units such as fingerprint sensors, image capture device for facial recognition, or microphones for voice recognition.

FIG. 16 includes one example of measurements for some dimensions of the dispensing interface 1600. In some embodiments, one or more of the measurements of the dispensing interface 1600 is different from the illustrated embodiment.

In some embodiments, a splashguard 1614 may be positioned on an underside surface of the dispensing interface 1600 to protect the user of the dispensing interface 1600 from splash back that may occur in dispensing a beverage or food-like substance.

FIG. 17A is an illustrative diagram of a pressurized container 1700 according to some embodiments. The pressurized container 1700 includes a lid portion 1702 and a hollow housing portion 1704.

The lid portion 1702 includes a lid cover 1706, a pressurized container interface 1708, a dispensing conduit 1710, and a display unit 1712. The lid cover 1706 may cover and protect one or more pressurized container interfaces 1708. The lid portion 1702 may be coupled to the hollow housing portion 1704 at a pivot point 1714, allowing the lid portion 1702 to be selectively opened and closed. A dispensing conduit may couple a compressible liquid volume stored within the hollow housing portion 1704 through the pressurized container interfaces 1708 to the dispenser 1612 of the dispensing interface 1600 of FIG. 16.

The hollow housing portion 1704 may include an outer portion 1716. The pressurized container may be airtight and operable to maintain a pressure level in an internal pressurized environment in the hollow housing portion. One or more compressible liquid volumes may be stored within the hollow housing portion of the hollow housing portion 1704. An increase in the pressure level of the internal pressurized environment in the hollow housing portion may cause liquid within the one or more compressible liquid volumes stored within the internal pressurized environment to flow through the pressurized container interfaces 1708 and the dispensing conduit 1710 to the dispensing interface. The pressure level of the internal pressurized environment may be provided through a pressure regulation system (not shown). The pressure regulation system may include at least one pressure conduit extending from the outer portion 1716 of the hollow housing portion 1704 through a pressure interface and into the hollow housing portion of the pressurized container.

In some embodiments, the display unit 1712 provides information regarding properties of the pressurized container 1700, such as a pressure level of the internal pressurized environment, a number of compressible liquid volumes within the hollow housing portion 1704, and an estimated amount of beverages or food-like substance in each of the compressible liquid volumes.

FIG. 17B is an illustrative diagram of the pressurized container 1700, where the lid portion 1702 is in an open position. A dispensing conduit 1718, which couples one of the multiple compressible liquid volumes (not shown) stored within the internal pressurized environment of the hollow housing portion 1704, can be seen.

FIG. 18 is an illustrative diagram of a dispensing system 1800 capable of re-alcoholizing and selectively dispensing beverages or food-like substances in some embodiments. The dispensing system 1800 includes a control system 1804, pressure system 1806, containers 1808, 1810, and 1812, a mixing mechanism 1814 and a dispensing unit 1816.

Similar to the control system 120 of FIG. 1A, the control system 1804 controls various aspects of the dispensing system 1800. In some embodiments, the control system 1804 controls features of the dispensing system 1800 (e.g., using the dispensing profile(s)), such as the amount of pressure applied to the pressurized container/cartridge, temperature, dispensing profiles, user profiles, solenoid valves, and dispense pour units.

The pressure system 1806 may provide pressure to push or propel the contents of one or more of the containers 1808, 1810, and 1812 through the liquid transport conduits coupled to the respective containers to the mixing mechanism 1814.

In some embodiments, liquid transport conduits 1822A, 1822B, and 1824 may be coupled to containers 1808, 1810, and 1812 respectively. Solenoids 1818A, 1818B, and 1820 may be controllable by the control system 1804. The solenoids may selectively couple the containers 1808, 1810, and 1812 to the mixing mechanism 1814.

Similar to the air-tight container 150 of FIG. 1A, containers 1808, 1810, and 1812 may be air-tight. The contents of containers 1808, 1810, and 1812 may include one or more ingredients of beverages such as beer. Beer concentrate may be re-alcoholized using vodka and water to produce beer. In some embodiments, vodka or low-proof vodka may be replaced with malt or malt syrup. The beer head (e.g., the frothy foam on top of some beer) may be produced using carbonated water. In one example, the beer dispensed by dispensing unit 1816 may not include a beer head. The dispensing unit 1816 may include some or all of the components of the dispensing pour units of FIG. 14A through 14C.

FIG. 20 is an example of a digital device in some embodiments. FIG. 20 is a block diagram illustrating entities of an example digital device able to read instructions from a machine-readable medium and execute those instructions in a processor to provide control functions, provide interfaces, receive commands, and the like as discussed herein. Specifically, FIG. 20 shows a diagrammatic representation of a digital device in the example form of a digital device 2000 within which instructions 2018 (e.g., software) for causing the machine to perform any one or more of the methodologies discussed herein may be executed. In alternative embodiments, the machine operates as a standalone device or may be connected (e.g., networked) to other machines, for instance, via the Internet.

The digital device may include a processor and memory and may include a PIC, processor, raspberry PI, or the like.

The example digital device 2000 includes a processor 2002 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 2004, and a static memory 2006, which are configured to communicate with each other via a bus 2008. The digital device 2000 may further include a graphics display unit 2010 (e.g., a plasma display panel (PDP), a liquid crystal display (LCD), a projector, or a cathode ray tube (CRT)). The digital device 2000 may also include a data store 2012 and a network interface device 2014, which are also configured to communicate via the bus 2008.

The data store 2012 includes a machine-readable medium 2016 on which is stored instructions 2018 (e.g., software) embodying any one or more of the methodologies or functions described herein. The instructions 2018 (e.g., software) may also reside, completely or at least partially, within the main memory 2004 or within the processor 2002 (e.g., within a processor's cache memory) during execution thereof by the digital device 2000, the main memory 2004 and the processor 2002 also constituting machine-readable media. The instructions 2018 (e.g., software) may be transmitted or received over a network (not shown) via optional network interface 2014.

While machine-readable medium 2016 is shown in an example embodiment to be a single medium, the term “machine-readable medium” should be taken to include a single medium or multiple media (e.g., a centralized or distributed database, or associated caches and servers) able to store instructions (e.g., instructions 2018). The term “machine-readable medium” shall also be taken to include any medium that is capable of storing instructions (e.g., instructions 2018) for execution by the digital device and that causes the machine to perform any one or more of the methodologies disclosed herein. The term “machine-readable medium” includes, but should not be limited to, data repositories in the form of solid-state memories, optical media, and magnetic media.

Thus, while there have been shown and described and pointed out fundamental novel features of the inventive system and method as applied to preferred embodiments thereof, it will be understood that various omissions and substitutions and changes in the form and details of the devices and methods illustrated and in their operation, may be made by those skilled in the art without departing from the spirit of the invention. For example, it is expressly intended that all combinations of those elements and/or method steps that perform substantially the same function in substantially the same way to achieve the same results are within the scope of the invention. It is the intention, therefore, to be limited only as indicated by the scope of the claims appended hereto.

1. A method comprising:
generating a pressurized environment within an incompressible, airtight pressurized container, the incompressible, pressurized container including a hollow housing portion and an outer portion, the pressurized container being airtight and operable to maintain a pressure level in the pressurized environment in the hollow housing portion, the pressurized environment being generated by a controllable pressure system coupled to the airtight pressurized container through a pressure delivery conduit;
receiving, from a user interface, a request for a serving of beer;
controlling, through a control interface, opening and closing a first liquid transport conduit and a second liquid transport conduit to enable a flow of beer concentrate from a first compressible container stored within the hollow housing portion and a flow of alcohol from a second compressible container stored within the hollow housing portion, respectively, the flow of beer concentrate and the flow of alcohol being propelled by pressure of the pressurized environment from within the hollow housing portion;
mixing, by a mixing apparatus, the flow of beer concentrate and the flow of alcohol to generate re-hydrated beer; and
dispensing the re-hydrated beer.

2. The method of claim 1, further comprising retrieving a profile based on the request for a serving of beer, the profile indicating a length of time to keep the first liquid transport conduit open and a second length of time to keep the second liquid transport conduit open, the controlling of opening and closing the first and second liquid transport conduits including opening and keeping open the first and second liquid transport conduits for the first length of time and the second length of time from the profile, respectively, and closing the first and second liquid transport conduits.

3. The method of claim 1, wherein opening and closing the first liquid transport conduit comprises opening a solenoid valve that allows the beer concentrate to flow through the first liquid transport conduit.

4. The method of claim 1, wherein the user interface and the control interface are part of a kiosk.

5. The method of claim 1, wherein the alcohol is vodka.

6. The method of claim 2, wherein the profile further indicates an amount of carbonation to add to the re-hydrated beer and the method further comprising adding the amount of carbonation to the re-hydrated beer prior to dispensing.

7. The method of claim 6, further comprising receiving an indication of an amount of head to have on the re-hydrated beer, the amount of carbonation being based on the indication of the amount of head.

8. The method of claim 6, wherein adding the amount of carbonation to the re-hydrated beer comprises adding carbonation to an amount of water received from a water line that is outside the incompressible pressurized container.

9. The method of claim 1, further comprising authenticating, by an authentication module, a consumer ID and dispensing the re-hydrated beer only if the consumer ID is authenticated.

10. A system comprising:
an incompressible, airtight pressurized container including a hollow housing portion and an outer portion, the pressurized container being airtight and operable to maintain a pressure level in a pressurized environment in the hollow housing portion, the pressurized environment being generated by a controllable pressure system coupled to the airtight pressurized container through a pressure delivery conduit;
a user interface configured to receive a request for a serving of beer;
a control interface configured to open and close a first liquid transport conduit and a second liquid transport conduit to enable a flow of beer concentrate from a first compressible container stored within the hollow housing portion and a flow of alcohol from a second compressible container stored within the hollow housing portion, respectively, the flow of beer concentrate and the flow of alcohol being propelled by pressure of the pressurized environment from within the hollow housing portion;
a mixing apparatus configured to mix the flow of beer concentrate and the flow of alcohol to generate re-hydrated beer; and
a dispensing system configured to dispense the re-hydrated beer.

11. The system of claim 10, further comprising data storage including a profile associated with the request for a serving of beer, the profile indicating a length of time to keep the first liquid transport conduit open and a second length of time to keep the second liquid transport conduit open, the control interface configured to open and close the first and second liquid transport conduits including the control interface configured to open and keep open the first and second liquid transport conduits for the first length of time and the second length of time from the profile, respectively, and close the first and second liquid transport conduits.

12. The system of claim 10, wherein the control interface configured to open and close the first liquid transport conduit comprises the control interface configured to open a solenoid valve that allows the beer concentrate to flow through the first liquid transport conduit.

13. The system of claim 10, wherein the user interface and the control interface are part of a kiosk.

14. The system of claim 10, wherein the alcohol is vodka.

15. The system of claim 11, wherein the profile further indicates an amount of carbonation to add to the re-hydrated beer and the system further comprising a carbonator configured to add the amount of carbonation to the re-hydrated beer prior to dispensing.

16. The system of claim 15, wherein the control interface is further configured to receive an indication of an amount of head to have on the re-hydrated beer, the carbonator being configured to provide amount of carbonation being based on the indication of the amount of head.

17. The system of claim 15, wherein the carbonator configured to add the amount of carbonation to the re-hydrated beer comprises the carbonator configured to add carbonation to an amount of water received from a water line that is outside the incompressible pressurized container.

18. The system of claim 10, further comprising an authentication module configured to authenticate a consumer ID and dispensing the re-hydrated beer only if the consumer ID is authenticated.
